(19) United States
(12) Patent Application Publication
(10) Pub. No.: US 2004/0131981 A1
(43) Pub. Date: Jul. 8, 2004

(54) Color developing solution of silver halide color photographic photosensitive material and manufacturing method of color developing solution

(76) Inventor: Hisao Kamo, Matsudo-Shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/696,307

(22) Filed: Oct. 30, 2003

(30) Foreign Application Priority Data
Oct. 31, 2002 (JP) 2002-318712

(51) Int. Cl. G03C 7/413

(52) U.S. Cl. 430/466; 430/486; 430/492; 430/450

(57) ABSTRACT

The present invention intends to provide a color developing solution of a silver halide color photographic photosensitive material that can be applied to a variety of photosensitive materials, can improve the workability and can obtain an improved image quality. The above objective can be achieved by using a color developing solution that includes a first processing solution containing a color developing agent having pH larger than 7, and a second processing solution containing an alkali agent, the compound having the pKa in a range of equal to or greater than 9 and equal to or less than 12 in a compound at least one kind of compounds shown in any one of the following general formulae (I), (II) and (III) having pKa equal to 9 or more and equal to 12 or less, and has the pH smaller than 13.5.

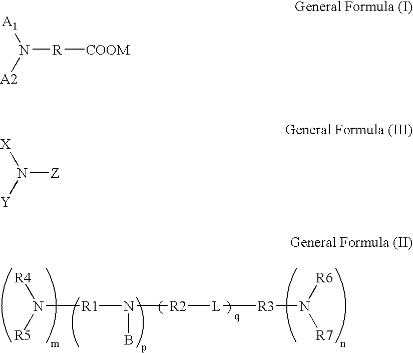

### BACKGROUND OF THE INVENTION

1. Field of the Invention

The present invention relates to a color developing solution for use in a silver halide color photographic photosensitive material that is used in, for instance, digital image processing or the like.

2. Description of the Related Art

In recent years, as image quality due to an ink jet printer is improved, in a developing process of a silver halide color photographic photosensitive material (hereinafter also referred to as “photosensitive material”), printing from digital data to a silver salt photographic paper (silver salt paper) and converting from a silver salt film to a digital data and to various kinds of media are becoming possible.

In order to perform various developing processes such as the printing from digital data or digitalization of a developed image of a photosensitive material, recently, digital mini-laboratories are growing popular. However, there are various demands for a smaller photosensitive material processor, rapid processing, reducing an amount of a waste solution after the processing, and the like.

In general, a developing process of a silver halide color photographic photosensitive material includes steps such as a color developing step, a bleaching step, a bleaching and fixing step or a fixing step, a rinsing step (including water rinsing) and a drying step. At present, various photosensitive materials have been developed and various kinds of automatic processors are in use. As a method used by the processors is that, having provided with the tanks filled with respective processing solutions and processing bathes, a photosensitive material, while being transferred by transferring means, is processed in the respective processing bathes provided.

The color developing step is performed with a color developing solution mainly made of a color developing agent and an alkali agent. That is, in the same time as reducing and precipitating silver in the photosensitive material caused by the color developing agent, the color developing solution is oxidized and thereby reacts with a coupler in the photosensitive material to form a dye, and thereby an image can be obtained. At this time, frequently, the color developing agent and the alkali agent are mixed in one solution and used (one solution processing). However, in such method, in many cases, in order to expedite the color developing process, the color developing solution is thickened or made highly alkaline. As a result, there occurs a problem in that the color developing solution tends to be oxidized by air and the stability thereof cannot be maintained. In addition, since a large amount of the color developing solution is used, an amount of waste solution is also large, causing a problem from an environmental point of view.

There have been proposed a variety of processing methods to overcome these problems. As a method particularly in high demand, a coating method in which on an image formation surface (also called as an emulsion surface) of the photosensitive material, a color developing solution is directly coated by use of a coating machine can be cited. In particular, a method where, in order to expedite the color developing process, the color developing solution is supplied by a minimum necessary amount (hereinafter referred to also as “a dry method”), as an amount of the waste solution can be reduced by a large amount, the method is preferable from the viewpoint of cost and environment.

However, when the color developing solution of existing one solution process is coated, since maintaining a concentration of the developing agent at a high concentration is difficult, a sufficient image cannot be obtained. In order to obtain a sufficient image density, a lot of solution has to be coated, resulting in exhaustion of a large amount of waste liquid, which is a failure as a dry process. Furthermore, permeating the developing agent uniformly on the photosensitive material is difficult, therefore causing a problem of forming an uneven image.

In this connection, in order to overcome such problems, Japanese laid open patent publication No.H02-203338 describes a method in which a color developing agent and an alkali agent are separated to perform an impregnation process in a processing bath (two solution impregnation method).

In addition, in Japanese laid-open patent publication Nos.H09-90579, H09-90580 and H09-90581, a method in which a low pH solution containing a color developing agent and an alkali agent are divided into two solutions and each of the solutions is separately coated on an image formation surface of a photosensitive material is described (two solution coating method).

However, even when such process is applied, an image having the finish equivalent to the one with C41 process, which is the standard process in photographic industry, cannot always be obtained from various kinds of photosensitive materials. When trying to obtain a uniform image from various kinds of photosensitive materials, problems such as needing to adjust the amount of solution to be coated according to each photosensitive material can occur which can be a cause decrease in operability.

In case of various photosensitive materials being processed under a constant coating amount, there causes a problem of extremely low image reproducibility in under exposure film and over exposure film, resulting in losing the gradation in a high density portion and a low density portion. When the photosensitive material processed in such a state is digitized and subjected to the image processing, the gradation cannot be recovered, which results in remarkable deterioration in finishing quality.

The present invention is achieved in view of the above circumstances, and intends to provide a color developing solution of a silver halide color photosensitive material that can be applied to various kinds of photosensitive materials, so that operability is improved, and as a result image quality of an obtained image can also be improved.

### SUMMARY OF THE INVENTION

The above object is accomplished by the following means.

That is, a color developing solution of a silver halide color photosensitive material according to the invention comprises a first processing solution containing a color developing agent having pH larger than 7 and a second processing solution containing an alkali agent and at least one kind of compounds having pKa in a range of equal to or greater than 9 and equal to or less than 12, the second processing solution having pH smaller than 13.5.

The first processing solution contains a p-phenylenediamine type color developing agent in the range of 0.1 mol/l to 2 mol/l.

The first processing solution has at least one kind of strong acid ions selected from the following compound group (A) by molar ratio of less than 1 with respect to p-phenylenediamine type color developing agent:

Compound Group (A)

Sulfate ion,

chloride ion,

nitrate ion,

p-toluenesulfonate ion, and

sulfonate ion.

The second processing solution contains the compound having the pKa in a range of equal to or greater than 9 and equal to or less than 12 and having pH 3.5 or less.

Moreover in the compound having the pKa in a range of equal to or greater than 9 and equal to or less than 12 is a compound shown in any one of the following general formulae (I), (II) and (III).

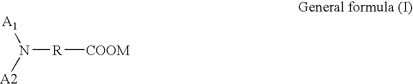

In the formula, A1, A2 each denote a hydrogen atom, a branched alkyl group having 1 to 6 carbon atoms, a straight chain alkyl group having 1 to 6 carbon atoms A1 or A2 may be connected with an R and form a heterocycle.

R denotes a branched alkylene group having 1 to 10 carbon atoms, straight chain alkylene group having 1 to 10 carbon atoms or cyclic alkylene group having 1 to 10 carbon atoms, the alkylene group may be substituted with one of an alkyl group having 1 to 3 carbon atoms, —OH, —NH₂, —SH, —PO₃M₂, —COOM, aryl group, indole group or guanidino group. The aryl group may be partially substituted with an OH group. The alkylene group and the substituent group may be connected through —O—, —S—, and M denotes hydrogen atom or an alkali metal.

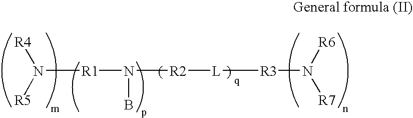

In the formula, R1, R2 each denote a branched alkylene group having 1 to 8 carbon atoms or a straight chain alkylene group having 1 to 8 carbon atoms.

The alkylene group may be substituted with —OH or —NH₂.

R3 denotes a branched alkylene group having 1 to 8 carbon atoms, a straight chain alkylene group having 1 to 8 carbon atoms, a cyclic alkylene group having 1 to 8 carbon atoms or an alkan-tri-yl group, and the alkylene group or the alkan-tri-yl group may be substituted with —OH or —NH₂.

R4, R5, R6, R7 each denote a hydrogen atom, a branched alkyl group having 1 to 8 carbon atoms, a straight chain alkyl group having 1 to 8 carbon atoms, and a cyclic alkyl group having 1 to 8 carbon atoms or an aryl group, and the alkyl group or the aryl group may be substituted with —COOM, —OH, or —PO₃M₂.

B denotes a hydrogen atom, a branched alkyl group having 1 to 4 carbon atoms or a straight chain alkyl group having 1 to 4 carbon atoms and the alkyl group may be substituted with —OH, —COOM, aryl group, or —PO₃M₂. L denotes S or O,

p and q each denote a number from 0 to 4, m+n denotes a number from 1 to 3.

M denotes a hydrogen atom or an alkali metal.

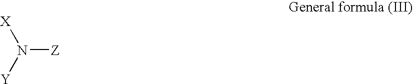

In the formula, X, Y, Z each denotes a hydrogen atom, a branched alkyl group having 1 to 8 carbon atoms or straight chain alkyl group having 1 to 8 carbon atoms, the alkyl group may be substituted with —COOM, —OH, —NH₂, —SH, —PO₃M₂, or aryl group. The aryl group may be substituted with —OH. X, Y and Z may combine with each other and form a ring, and M denotes a hydrogen atom or an alkali metal.

The first processing solution contains a p-phenylenediamine type color developing agent in the range of 0.1 mol/l to 2 mol/l.

The second processing solution contains the compound having the pKa in a range of equal to or greater than 9 and equal to or less than 12 and having pH 13.5 or less.

The first processing solution supplies the color developing agent to the silver halide color photographic photosensitive material at a rate ranging from 0.01 mol/m² to 0.5 mol/m².

Furthermore, a manufacturing method of a color developing agent part processing solution according to the present invention comprising the steps of, adding a neutralizing agent to an aqueous solution of an acid adduct of the p-phenylenediamine type color developing agent to have the neutralizing agent react with the strong acid ion and precipitating and removing a reaction product obtained according to the reaction. In addition the amount of added neutralizing agent ranges from 0.5 to 2.5 times by mole of an acid adducted to the color developing agent. Still furthermore, a concentration of the strong acid ion is preferably in the range of 0 time to 1 times by mole the color developing agent, that is, less than an equivalent mole.

### DESCRIPTION OF THE PREFERRED EMBODIMENTS

In the following, modes for carrying out the present invention will be explained.

<Color Developing Solution>

To begin with, a color developing solution according to the invention will be explained.

The color developing solution according to the invention includes two parts, a color developing agent part processing solution (hereinafter also referred to as a color developing agent part solution) as the first processing solution and an alkali part processing solution (hereinafter referred to as an alkali solution) as the second solution. The first solution contains a color developing agent of more than 7 in the pH, and the second processing solution contains an alkali agent, at least one kind of compound whose pKa is in a range between 9.0 or more and 12.0 or less, and less than 13.5 in the pH.

Many of the color developing agent part solution used in the conventional two solution method is low in the pH, that is, strong acidic; accordingly, when an alkali agent is coated in the back end process, the color developing agent part of the processing solution vigorously reacts with the alkali agent, causing a problem in that a reaction between the color developing agent part solution and the alkali part solution does not occur uniformly which results in an image unevenness. However, since color developing agent part solution of the present invention has pH in the neighborhood of the neutrality, no vigorous reaction occurs when reacted with the alkali agent, which could results in a stable color developing reaction.

Furthermore, in the case of the color developing agent part solution having low pH, since the permeation efficiency into the photosensitive material is not so good either, permeation unevenness tends to occur. Still furthermore, since the color developing solution itself has to be coated in large amount, the problem of over flowing the solution occurred. However, in the range of the pH of the color developing solution according to the invention, even with a small amount, the photosensitive material can rapidly permeate into the photosensitive material, inhibiting uneven color development at the time of development.

Still furthermore, since an amount of the color developing solution to be coated becomes less, sufficient development reaction can be obtained with a smaller amount of the alkali agent, which enables to obtain sufficient image density in a shorter time, thereby, the working efficiency can also be improved.

In the following, the composition of the color developing agent part solution and the alkali part processing solution will be explained in detail.

Color Developing Agent Part Solution

As the color developing agents to be used in the color developing agent part solution, sulfates, hydrochlorides, nitrates or p-toluene sulfonates of p-phenylenediamine type compounds may be appropriately used, and two or more kinds thereof may be used in combination depending on its use. Moreover, the above salts and p-phenylenediamine type compounds themselves may be used in combination.

In the existing process, since such an acid adduct is used, the color developing agent part solution itself becomes low in pH and, in some cases, the reaction with the alkali agent is not processed well. However, in the case of the color developing agent part solution of the present invention, since a strong acid ion of the color developing agent is forcibly precipitated and removed in a process described later, the stability of the processing is improved. As the p-phenylenediamine type compounds, so-called free color developing agent which is not an acid adduct can be used, and, in this case, the process can be carried out without neutralization to remove strong acid ion as described later.

As examples of the p-phenylenediamine type compounds, 3-methyl-4-amino-N, N-diethylaniline, 3-methyl-4-amino-N-ethyl-N-β-hydroxyethylaniline, 3-methyl-4-amino-N-ethyl-N-β-methanesulfonamideethylaniline, 3-methyl-4-amino-N-ethyl-N-β-methoxyethylaniline, 4-amino-3-methyl-N-methyl-N-(3-hydroxypropyl)aniline, 4-amino-3-methyl-N-ethyl-N-(3-hydroxypropyl)aniline, 4-amino-3-methyl-N-ethyl-N-(2-hydroxypropyl)aniline, 4-amino-3-ethyl-N-ethyl-N-(3-hydroxypropyl)aniline, 4-amino-3-methyl-N-propyl-N-(3-hydroxypropyl)aniline, 4-amino-3-propyl-N-methyl-N-(3-hydroxypropyl)aniline, 4-amino-3-methyl-N-methyl-N-(4-hydroxybutyl)aniline, 4-amino-3-methyl-N-ethyl-N-(4-hydroxybutyl)aniline, 4-amino-3-methyl-N-propyl-N-(4-hydroxybutyl)aniline, 4-amino-3-ethyl-N-ethyl-N-(3-hydroxy-2-methylpropyl)aniline, 4-amino-3-methyl-N,N-bis(4-hydroxybutyl)aniline, 4-amino-3-methyl-N, N-bis(5-hydroxypentyl)aniline, 4-amino-3-methyl-N-(5-hydroxypentyl)-N-(4-hydroxybutyl) aniline, 4-amino-3-methoxy-N-ethyl-N-(4-hydroxybutyl)aniline, 4-amino-3-ethoxy-N, N-bis(5-hydroxypentyl)aniline, 4-amino-3-propyl-N-(4-hydroxybutyl)aniline, and sulfates, hydrochlorides, nitrates, p-toluene sulfonates or sulfonates thereof can be cited.

Furthermore, preferably, compounds such as 4-amino-3-methyl-N, N-diethylaniline, 4-amino-3-methyl-N-(β-hydroxyethyl)aniline, 4-amino-3-methyl-N-ethyl-N-(β-methanesulfonamidoethyl)aniline, 4-amino-3-methyl-N-ethyl-N-(β-hydroxyethyl)aniline, 4-amino-3-(β-methanesulfonamidoethyl)aniline, 4-amino-3-methyl-N-(β-methoxyethyl)aniline, 4-amino-3-butyl-N-(β-butyl sulfonate)aniline, and sulfates, hydrochlorides, nitrates, p-toluene sulfonates and sulfonates thereof can be cited.

A content of the color developing agent in the color developing agent part solution according to the present invention is in the range of from 0.1 mol/l to 2 mol/l, preferably from 0.15 mol/l to 1.0 mol/l, and more preferably from 0.2 mol/l to 0.5 mol/l.

Furthermore, the color developing agent part solution according to the present invention has pH exceeding 7.0, preferably in the range of 7.0 to 10, and more preferably from 7.0 to 8.0.

When the pH is 7.0 or less, vigorous reaction occurs when the alkali part solution is coated, causing coating unevenness. Furthermore, when pH is 10 or more, highly concentrated solution cannot be obtained, causing a problem of not being able to reduce the amount of waste solution.

In order to obtain such pH, alkali agents such as potassium hydroxide, sodium hydroxide or lithium hydroxide can be preferably added as a neutralizing agent.

According to the color developing agent part solution of the present invention, by previously controlling pH to more than the neutrality with the neutralizing agent or the like, when the alkali part solution is coated, the vigorous reaction can be inhibited from occurring and, furthermore, after the neutralization process, by forcibly precipitating and removing the strong acid ions contained in the color developing agent as salts thereof, the strong acid ions can be efficiently inhibited from precipitating on the photosensitive material at the time of processing.

Concentrations of sulfate ion, chloride ion, nitrate ion, p-toluenesulfonate ion and sulfonate ion in thus prepared color developing agent part solution, molar ratio with respect to the color developing agent is preferably less than 1. By controlling the molar ratio to less than 1, the strong acid ions can be efficiently inhibited from precipitating on the photosensitive material at the processing.

Preferably, the molar ratio is in the range of 0 to 0.8 and more preferably 0 to 0.5.

Thus, when the color developing agent is in a state where an adduct with an acid is not formed (so-called free), the color developing agent can be used in the color developing agent part solution as it is. However, ordinarily, the color developing agent forms an adduct with the sulfate ion, chloride ion, nitrate ion, p-toluenesulfonate ion and sulfonate ion in a raw material stag. However, even in such case, by precipitating the strong acid ions attached to the color developing agent due to the neutralization reaction in a salt state and thereby removing this salt, the color developing agent can be contained by an amount larger than usual. Accordingly, even when an amount of the color developing agent that is coated on the photosensitive material is reduced, a sufficient amount of the color developing agent can be supplied on the photosensitive material, resulting in obtaining a necessary and sufficient image density.

Furthermore, when thus composed, in the case of the solution being reserved in cold climates, the solution can be suppressed from precipitating crystals in particular owing to lower temperature which is convenient for maintaining quality of the color developing agent part solution.

Still furthermore, as an antioxidant a sulfite compound can be added to the color developing agent part solution.

For instance, sulfites such as ammonium sulfite, potassium sulfite or sodium sulfite, bisulfites such as ammonium bisulfite, potassium bisulfite or sodium bisulfite, metabisulfites such as ammonium metabisulfite, potassium metabisulfite or sodium metabisulfite, hydroxyl amines, reductones and sulfinic acids can be cited.

A concentration of bisulfite in the color developing agent part solution is in the range of 0.0001 mol/l to 1.5 mol/l, preferably 0.001 mol/l to 1.2 mol/l, and more preferably from 0.005 mol/l to 1.0 mol/l.

An existing color developing agent part solution is strongly acidic. In such circumstance, sulfurous acid is difficult to be dissolved and released as sulfur dioxide from the solution, thereby causing inconvenience of emitting foul odor. However, since the color developing agent part solution of the color developing solution of the present invention has pH in the neighborhood of neutrality, sulfurous acid can be added more than ever, which can improve the preservation stability of the solution. In addition, even the sulfurous acid is added to large amount, does not generate odor of sulfurous acid.

Furthermore, according to the present invention, by removing the strong acid ion beforehand, the strong acid ion can be effectively inhibited from precipitating during the processing. However, in order to further improve the removal efficiency, a so far known compound can be appropriately added as a solvent. In that case, two kinds or more may be used in combination.

As examples, for instance, alkyl alcohols such as methyl alcohol, ethyl alcohol, n-propyl alcohol, isopropyl alcohol, n-butyl alcohol, sec-butyl alcohol, tert-butyl alcohol, isobutyl alcohol, benzyl alcohol, and cyclohexanol or halogenated derivatives thereof; amides such as dimethyl formamide, dimetyl acetamide; ketones or ketoalcohols such as acetone, diacetone alcohol; ethers such as tetrahydrofuran, dioxane; oxyethylenes or oxypropylene addition polymers such as diethylene glycol, triethylene glycol, tetraethylene glycol, dipropylene glycol, tripropylene glycol, polyethylene glycol, polypropylene glycol; alkylene glycols such as ethylene glycol, propylene glycol, trimethylene glycol, butylene glycol, 1,2,6-hexanetriol, hexylene glycol; lower alkyl ethers of polyhydric alcohols such as thiodiglycol, glycerin, ethylene glycol monoalkyl ether, diethylene glycol monoalkyl ether, triethylene glycol monoalkyl ether; and heterocyclic ketones such as sulfolane, N-methyl-2-pyrohlidone, 1,3-dimethyl-2-imidazoline can be cited.

Among these, methyl alcohol, ethyl alcohol, tert-butyl alcohol, diethylene glycol, triethylene glycol, polyethylene glycol, ethylene glycol, propylene glycol, thiodiglycol, glycerin, N-methyl-2-pyrohlidone, 1,3-dimethyl-2-imidazoline are preferable. Among these, methyl alcohol, diethylene glycol and N-methyl-2-pyrohlidone are more preferable.

An addition amount is in the range of 0 w/v percent to 50 w/v percent, preferably 0 w/v percent to 40 w/v percent, and more preferably from 0 w/v percent to 30 w/v percent.

Furthermore, when the coating is under suspension, in a coating machine in which the processing method of the present invention is used, at a coating nozzle or coating head portion from occurring, an anti-drying agent may be added in order to inhibit coating failure due to crystallization or drying of the coating liquid.

As examples of the anti-drying agent, oxyethylene or oxypropylene addition polymers such as diethylene glycol, triethylene glycol, tetraethylene glycol, dipropylene glycol, tripropylene glycol, polyethylene glycol, polypropylene glycol, alkylene glycols such as ethylene glycol, propylene glycol, trimethylene glycol, butylene glycol, 1,2,6-hexanetriol, hexylene glycol, lower alkyl ethers of polyhydric alcohols such as thiodiglycol, glycerin, ethylene glycol monoalkyl ether, diethylene glycol monoalkyl ether, triethylene glycol monoalkyl ether, and heterocyclic ketones such as N-methyl-2-pyrohlidone, 1,3-dimethyl-2-imidazoline can be cited.

Polyhydric alcohols such as diethylene glycol, triethylene glycol, polyethylene glycol, ethylene glycol, propylene glycol, thiodiglycol, glycerin can be preferably used. More preferably, diethylene glycol, triethylene glycol and glycerin can be cited.

Furthermore, when the color developing agent part solution is coated on a photosensitive material coating surface, in order to uniformly coat the processing solution, an organic solvent or a surfactant may be added to control surface tension of the processing solution. In this case, two or more kinds may be used in combination.

As examples of the organic solvent, lower alcohol ethers of polyhydric alcohols such as ethylene glycol, diethylene glycol, triethylene glycol, propylene glycol, dipropylene glycol, tripropylene glycol, ethylene glycol methyl ether, ethylene glycol ethyl ether, ethylene glycol propyl ether, ethylene glycol butyl ether, diethylene glycol methyl ether, diethylene glycol ethyl ether, diethylene glycol propyl ether, diethylene glycol butyl ether, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether can be cited.

Furthermore, as examples of the surfactant, anionic surfactants such as aliphatic acid salts, hydroxyalkane sulfonates, alkane sulfonates, dialkyl sulfosuccinates, alkylbenzene sulfonates, alkylnaphthalene sulfonates, polyoxyethylene alkylsulfenyl ether salts, alkylsulfuric acid ester salts, polyoxyethylene alkylether sulfuric acid ester salts, aliphatic acid monoglyceride sulfuric acid ester salts, polyoxyethylene alkylether phosphoric acid ester salts, perfluoroalkyl carboxylic acid, perfluoroalkyl sulfonic acid, perfluoroalkyl phosphoric acid and nonionic surfactants such as polyoxyethylene alkyl ethers, polyoxyethylene alkyl phenyl ethers, polyoxyethylene polyoxypropylene alkyl ethers, polyoxyethylene sorbitane aliphatic acid esters, polyoxyethylene sorbitol aliphatic acid esters, polyethylene glycol aliphatic acid esters, perfluoroalkyl ethylene oxide adducts, poly(oxyethylene, oxypropylene)methyl polysiloxane copolymers, polyoxyethylene/methylpolysiloxane copolymer, acetylene glycol ethylene oxide adducts can be cited.

Among these, anionic type surfactants such as dialkyl sulfosuccinates, alkylnaphthalene sulfonates, polyoxyethylene alkylether phosphoric acid ester salts and perfluoroalkyl carboxylic acid and nonionic type surfactants such as polyoxyethylene/methylpolysiloxane copolymers and acetylene glycol ethylene oxide adducts can be preferably cited.

Furthermore, when the color developing agent part solution is coated on a photosensitive material coating surface, in order to enable to uniformly coat the processing solution, a surface tension adjusting agent or a surfactant may be added to control the surface tension of the processing solution. In this case, two or more kinds may be used in combination.

Among these, as an organic solvent, ethylene glycol and ethylene glycol butyl ether can preferably be used, and as the surfactant, dialkyl sulfosuccinates, polyoxyethylene alkylether phosphoric acid ester salts, perfluoroalkyl carboxylic acid, perfluoroalkyl sulfonic acid, polyoxyethylene/methylpolysiloxane copolymers and acetylene glycol ethylene oxide adducts can preferably be used.

As the surface tension adjusting agent, an amount of the organic solvent to be added is in the range of from 0 w/v percent to 50 w/v percent and preferably from 0 w/v percent to 30 w/v percent.

Furthermore, an amount of the surfactant to be added is in the range of from 0 w/v percent to 20 w/v percent, and preferably from 0 w/v percent to 5 w/v percent. The surface tension of the color developing agent part solution adjusted by the addition of the additives is preferably in the range of 24 mN/m to 72 mN/m (measurement temperature from 20 degree centigrade to 60 degree centigrade), and more preferably from 25 mN/m to 55 mN/m (measurement temperature in a range of 20 degree centigrade to 60 degree centigrade).

Thus adjusted color developing agent part solution, when coated on the photosensitive material, can favorably permeate into the photosensitive material without being repelled.

Furthermore, in the processing solution according to the invention, in order to inhibit the processing solution from over flowing from the surface of the photosensitive material when coating on the surface and thereby to allow uniform coating on the photosensitive material, a viscosity adjusting agent may be added.

As the viscosity adjusting agent, for instance, cellulose derivatives such as carboxymethyl cellulose and hydroxypropyl methylcellulose, alginates, polyvinyl alcohol, polyvinyl pyrrolidone, carboxy vinyl polymers, polyethylene glycol, polyacrylic acid amide, and acrylic acid methacrylic acid copolymers can be used.

An amount of the viscosity adjusting agent to be added is in the range of from 0 w/v percent to 20 w/v percent, preferably from 0 w/v percent to 10 w/v percent, and more preferably from 0 w/v percent to 5 w/v percent.

The viscosity of the color developing agent part solution that can be obtained by adding the viscosity adjusting agent is preferably 30000 cp or less (measurement temperature in a range of 20 degree centigrade to 50 degree centigrade), and more preferably in the range of 0.5 cp to 5000 cp (measurement temperature in a range of 20 degree centigrade to 50 degree centigrade).

Alkali Part Processing Solution

Subsequently, the alkali part processing solution will be explained.

The alkali part processing solution of the present invention is a processing solution that includes an alkali agent and as pH buffering agent a compound whose pKa is in a range between 9.0 or more and less than 12.0, which is described later, and has pH less than 13.5.

First, as the alkali agent contained in the alkali part processing solution, a compound such as potassium hydroxide, sodium hydroxide or lithium hydroxide can be cited.

A content of the alkali agent other than the one exists as a salt of the buffering agent of the alkali agent is preferably in the range of 0.1 mol/l to 5 mol/l, and more preferably in the range of 0.1 mol/l to 3 mol/l.

Furthermore, the alkali part processing solution may preferably contain at least one of compounds represented by general formulas (I), (II) and (III) below.

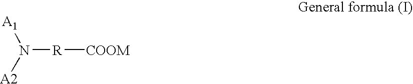

In the formula, A1, A2 each denote a hydrogen atom, a branched alkyl group having 1 to 6 carbon atoms, a straight chain alkyl group having 1 to 6 carbon atoms A1 or A2 may be connected with an R and form a heterocycle. The number of carbon atoms is preferably from 1 to 3.

Further, R denotes a branched alkylene group having 1 to 10 carbon atoms, straight chain alkylene group having 1 to 10 carbon atoms or cyclic alkylene group having 1 to 10 carbon atoms. The alkylene group may be substituted with one of an alkyl group having 1 to 3 carbon atoms, —OH, —NH₂, —SH, —PO₃M₂, —COOM, aryl group, indole group or guanidino group. The aryl group may be partially substituted with an OH group. The alkylene group and the substituent group may be connected through —O—, —S—, and M denotes hydrogen atom or an alkali metal.

As examples of the above compounds, the followings can be cited.

[Compound I]

| No. | Structure | Pka | |
|---|---|---|---|
| I-1 | H₂N—CH₂—COOH | pKa | 9.68 |
| | | 9.78 | |
| | | (at two step | |
| | | dissociation) | |
| I-2 | H₃C—NH—CH₂—COOH | 10.01 | |
| I-3 | 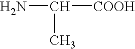 | 9.87 | |
| I-4 | H₂N—C₂H₄—COOH | 10.26 | |
| I-5 | 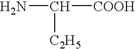 | 9.66 | |
| I-6 | 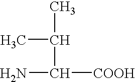 | 9.62 | |
| I-7 | 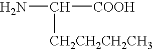 | 9.96 | |
| I-8 | 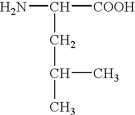 | 9.78 | |
| I-9 | 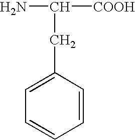 | 9.18 | |
| I-10 | 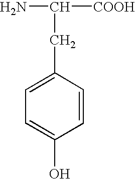 | 10.43 | |
| I-11 | 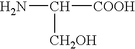 | 9.12 | |
| I-12 | 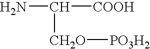 | 9.74 | |
| I-13 | 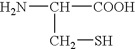 | 10.28 | |
| I-14 | 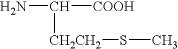 | 9.13 | |
| I-15 | 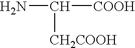 | 9.62 | |
| I-16 | 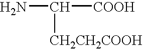 | 9.67 | |
| I-17 | 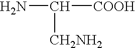 | 9.50 | |
| I-18 | 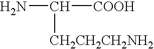 | 10.73 | |
| I-19 | 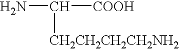 | 10.72 | 9.18 |
| I-20 | 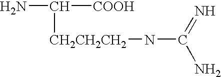 | 9.08 | |
| I-21 | H₅C₂—NH—CH₂—COOH | 10.10 | |
| I-22 | CH₃CH₂CH₂—NH—CH₂COOH | 10.03 | |
| I-23 | 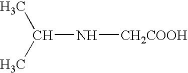 | 10.06 | |
| I-24 | 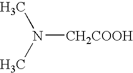 | 9.80 | |
| I-25 | 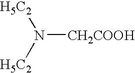 | 10.47 | |
| I-26 | 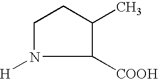 | 10.68 | |
| I-27 | 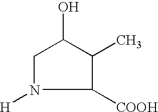 | 9.58 | |
| I-28 | 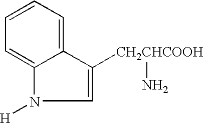 | 9.55 | |
| I-29 | 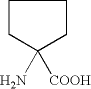 | 10.31 | |
| I-30 | 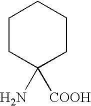 | 10.13 | |
| I-31 | 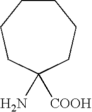 | 10.46 | |

All of the above-mentioned compounds (I) can be preferably used; however, I-1, I-3, I-4, I-17 and I-20 can preferably be used.

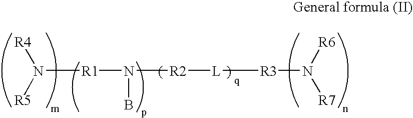

In the formula, R1, R2 each denote a branched alkylene group having 1 to 8 carbon atoms or a straight chain alkylene group having 1 to 8 carbon atoms. The alkylene group may be substituted with —OH or —NH₂.

R3 denotes a branched alkylene group having 1 to 8 carbon atoms, a straight chain alkylene group having 1 to 8 carbon atoms, a cyclic alkylene group having 1 to 8 carbon atoms or an alkan-tri-yl group, and the alkylene group or the alkan-tri-yl group may be substituted with —OH or —NH₂.

R4, R5, R6, R7 each denote a hydrogen atom, a branched alkyl group having 1 to 8 carbon atoms, a straight chain alkyl group having 1 to 8 carbon atoms, and a cyclic alkyl group having 1 to 8 carbon atoms or an aryl group, and the alkyl group and the aryl group may be substituted with —COOM, —OH, or —PO₃M₂.

B denotes a hydrogen atom, a branched alkyl group having 1 to 4 carbon atoms or a straight chain alkyl group having 1 to 4 carbon atoms and the alkyl group may be substituted with —OH, —COOM, aryl group, or —PO₃M₂. L denotes S or O, p and q each denote a number from 0 to 4, m+n denotes a number from 1 to 3.

M denotes a hydrogen atom or an alkali metal.

As examples of such compounds, the following can be cited.

[Compound II]

| No. | Structure | Pka | |
|---|---|---|---|
| II-1 | 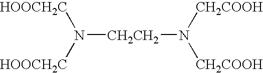 | 10.23 | |
| II-2 | 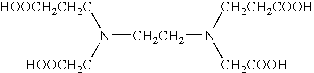 | 9.83 | |
| II-3 | 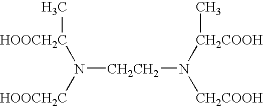 | 10.60 | |
| II-4 | 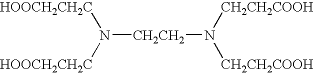 | 9.60 | |
| II-5 | 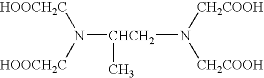 | 10.84 | |
| II-6 | 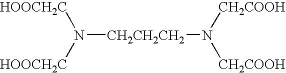 | 10.27 | |
| II-7 | 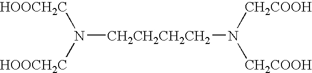 | 10.45 | |
| II-8 | 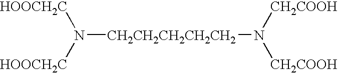 | 10.50 | |
| II-9 | 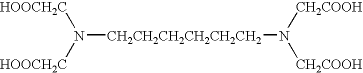 | 9.75 | |
| II-10 | 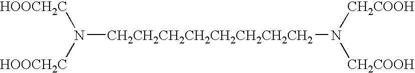 | 10.70 | |
| II-11 | 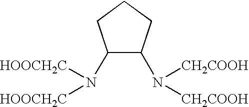 | 10.31 | |
| II-12 | 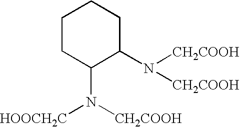 | 11.70 | |
| II-13 | 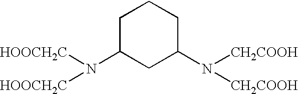 | 10.91 | |
| II-14 | 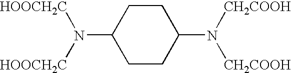 | 10.86 | 9.04 |
| II-15 | 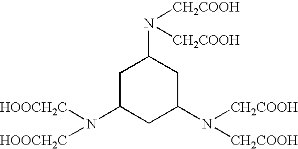 | 10.60 | |
| II-16 | 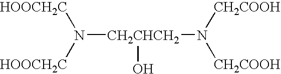 | 9.70 | |
| II-17 | 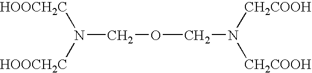 | 9.47 | |
| II-18 | 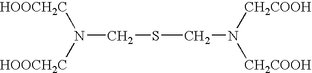 | 9.42 | |
| II-19 | 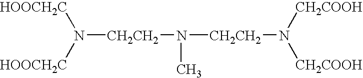 | 10.89 | |
| II-20 | 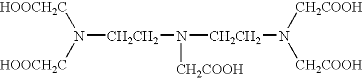 | 9.08 | |
| II-21 | 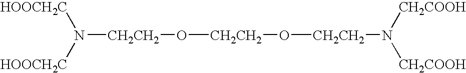 | 9.46 | |
| II-22 | 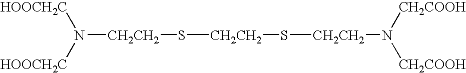 | 9.22 | |
| II-23 | 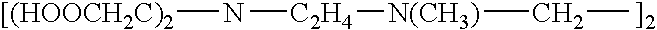 | 10.54 | |
| II-24 | 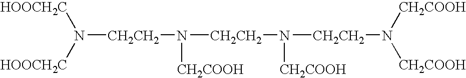 | 10.33 | 9.35 |
| II-25 | 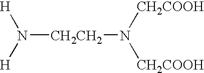 | 11.05 | |
| II-26 | HOOCH₂C—NH—C₂H₄—NH—CH₂COOH | 9.57 | |
| II-27 | HOOCH₄C₂—NH—C₂N₄—NH—C₂H₄COOH | 9.58 | |
| II-28 | 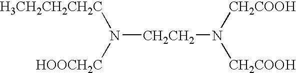 | 10.04 | |
| II-29 | 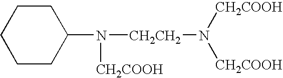 | 10.15 | |
| II-30 | 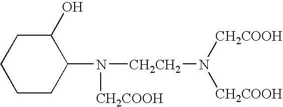 | 10.38 | |
| II-31 | 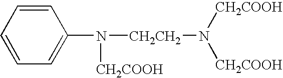 | 9.84 | |
| II-32 | H₂N—C₂H₄—NH₂ | 10.18 | |
| II-33 | H₃C—NH—C₂H₄—NH₂ | 10.40 | |
| II-34 | H₅C₂—NH—C₂H₄—NH₂ | 10.56 | |
| II-35 | H₇C₃—NH—C₂H₄—NH₂ | 10.34 | |
| II-36 | 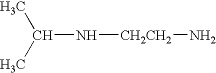 | 10.62 | |
| II-37 | HOH₄C₂—NH—C₂H₄—NH₂ | 10.12 | |
| II-38 | 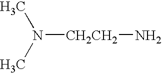 | 10.00 | |
| II-39 | 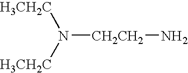 | 10.02 | |
| II-40 | 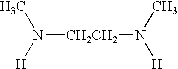 | 10.29 | |
| II-41 | 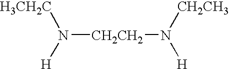 | 10.46 | |
| II-42 | 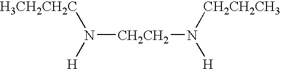 | 10.27 | |
| II-43 | 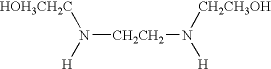 | 9.43 | |
| II-44 | 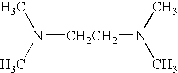 | 10.13 | |
| II-45 | CH₃—CH(NH₂)—CH₂—NH₂ | 10.00 | |
| II-46 | NH₂—CH(CH₃)—CH(CH₃)—NH₂ | 9.97 | |
| II-47 | H₂N—C₃H₆—NH₂ | 10.62 | |
| II-48 | H₂N—C₄H₈—NH₂ | 10.82 | 9.61 |
| II-49 | H₂N—C₅H₁₀—NH₂ | 10.96 | 10.02 |
| II-50, 51 | 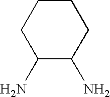 | 9.99(cis) | 9.89(trans) |
| II-52 | 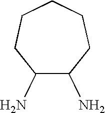 | 10.48 | |
| II-53 | 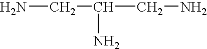 | 9.59 | |
| II-54 | 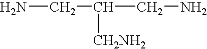 | 9.94 | 9.13 |
| II-55 | H₂N—C₃H₆—NH—C₃H₆—NH₂ | 11.70 | 10.77 |
| II-56 | H₂N—C₂H₄—NH—C₂H₄—NH—C₂H₄—NH₂ | 9.92 | 9.20 |
| II-57 | H₂N—CH—₂CH(CH₂NH₂)—CH₂—NH₂ | 9.92 | 9.20 |

Among the above compounds, II-1, II-2, II-3, II-4, II-5, II-6, II-7, II-16, and II-20 are preferable. Furthermore, II-1, II-5, II-6 and II-20 are more preferable.

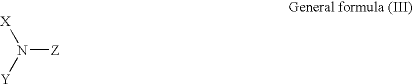

In the formula, X, Y, Z each denotes a hydrogen atom, a branched alkyl group having 1 to 8 carbon atoms or straight chain alkyl group having 1 to 8 carbon atoms, more preferably with 1 to 3 carbon atoms. Further, in the formula, X, Y and Z may combine each other to form a ring.

The alkyl group may be substituted with —COOM, —OH, —NH₂, —SH, —PO₃M₂, or aryl group. The aryl group may be substituted with —OH.

In addition, M denotes a hydrogen atom or alkali metal.

As such compounds, compounds shown below can be cited.

[Compound III]

| No. | Structure | Pka |
|---|---|---|
| III-1 | 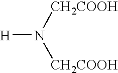 | 9.12 |
| III-2 | 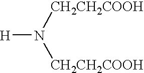 | 10.31 |
| III-3 | 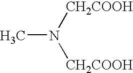 | 10.60 |
| III-4 | 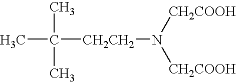 | 10.24 |
| III-5 | 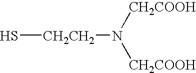 | 10.79 |
| III-6 | 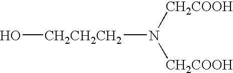 | 9.24 |
| III-7 | 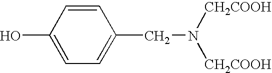 | 11.79 |
| III-8 | 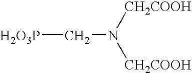 | 10.76 |
| III-9 | 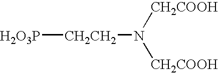 | 10.46 |
| III-10 | 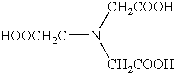 | 9.73 |
| III-11 | 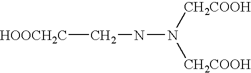 | 9.35 |
| III-12 | 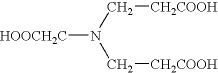 | 9.37 |
| III-13 | 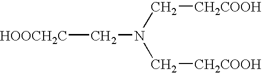 | 9.30 |
| III-14 | 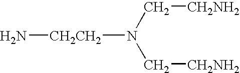 | 9.60 |
| III-15 | HO—H₄C₂—NH₂ | 9.60 |
| III-16 | CH₃—O—C₂H₄—NH₂ | 9.61 |
| III-17 | 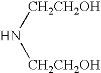 | 9.00 |

Among these compounds, III-1,III-3, III-13 and III-17 can preferably be used.

pKa of these compounds may be in the range of 9 to 12, preferably 9 to 11.6, and more preferably 9.0 to 11.

Furthermore, when one of the above-mentioned compounds is used as the pH buffering agent of the alkali part processing solution of the color developing solution according to the present invention, the pH of the alkali part processing solution can be made in a range between 9 or more and less than 13.5, however, it is preferable to be made in a range between 10 or more and less than 13.0, and more preferable to be made in a range between 10.0 or more and less than 12.5. When the pH is made 13.5 or more, the fog is caused in a Dₘᵢₙ portion and the gradation is lost in a low density portion and high density portion of the characteristic curve, resulting in remarkably deteriorating the image reproducibility. Accordingly, the pH of the alkali part processing solution is necessarily made less than 13.5. However, when the pH buffering agent according to the invention is not used, the development activity becomes low and a sufficient image density cannot be obtained, that is, the image reproducibility is low. Accordingly, when the pH of the alkali agent is made less than 13.5 and the pH buffering agent according to the invention is added, the development activity can be prevented from deteriorating, enabling the image reproducibility to be maintained.

Furthermore, an amount of these compounds to be added need only be in the range of from 0.07 mol/L to 2 mol/L, preferably from 0.1 mol/L to 1.5 mol/L, and more preferably from 0.2 mol/L to 1 mol/L. If the content is in the above range it is possible to allow pH to be in the above-mentioned range, and thereby the processing can be efficiently forwarded.

Still furthermore, in order to inhibit the fog from occurring, a development inhibitor can be added. As examples, chlorides, bromides and iodides of alkali metals, benzimidazoles and benzthiazoles can be cited. Among these, bromides are preferable. Furthermore, an amount to be added may be in the range of 0 mol/l to 1.0 mol/l, preferably from 0 mol/l to 0.5 mol/l, and more preferably from 0 mol/l to 0.3 mol/l.

Furthermore, when coating of an alkali solution is suspended, in a coating nozzle or head, the solution crystallizes or dries, resulting in coating failure after the coating is once more started. Accordingly, in order to prevent the coating failure from occurring, the same anti-drying agent identical as that in the color developing agent part solution may be added. In that case, as applicable compounds, ones identical as the compounds that are used in the above developing part processing solution can be used. An amount of the anti-dry agent to be added is in the range of from 0 w/v percent to 50 w/percent, preferably from 0 W/v percent to 40 W/v percent, and more preferably from 0 W/v percent to 30 W/v percent.

Still furthermore, in order to improve the permeability when the alkali solution is coated on a photosensitive material, the same surface tension adjusting agent as that in the developing part processing solution may be added. The surface tension of the alkali part solution after the addition is preferably in the range of from 20 mN/m to 72 mN/m (measurement temperature in the range of 20 to 50 degree centigrade) and more preferably from 25 mN/m to 50 mN/m (measurement temperature in the range of 20 to 50 degree centigrade).

Furthermore, in order to prevent the processing solution from overflowing during coating and thereby to enable to uniformly coat the processing solution on the photosensitive material, the same viscosity adjusting agent as that in the color developing agent part solution may be added. Viscosity of the processing solution after addition of the agent is preferably 30000 cp or less (measurement temperature in the range of 20 to 50 degree centigrade), more preferably in the range of 0.5 cp to 5000 cp (measurement temperature in the range of 20 to 50 degree centigrade).

To the color developing solution thus prepared, an organic preservative or fluorescent whitening agent may be appropriately added.

For instance, as the organic preservative, used for both the color developing agent part solution and the alkali part processing solution, hydroxylamine, hydroxylamine derivatives or compounds expressed by a following general formula (IV) (general formula [I] described in Japanese laid-open patent publication No.2000-162750) may be added.

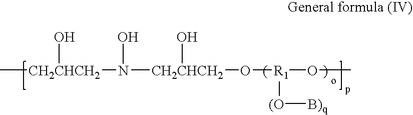

An amount to be added in this case is preferably from 0.0005 mol/l to 0.08 mol/l, and more preferably from 0.01 mol/l to 0.06 mol/l.

Furthermore, commonly for both the developing agent part solution and the alkali part processing solution, a surfactant such as polyoxyethylene alkylphenyl ether, or a triazinylstilbene type fluorescent whitening agent may be added.

An amount to be added in this case is preferably from 2 g to 30 g per liter.

By preparing the color developing agent part solution as explained above, in the case of the alkali part solution being coated, a neutralizing reaction occurs on a surface of the photosensitive material without causing coating irregularity, and since the permeability to the photosensitive material and the reactivity with the developing agent are also improved, high quality image can be obtained.

<Method of Manufacturing Color Developing Solution>

In the next place, a method of manufacturing a color developing solution according to the present invention will be explained.

The color developing solution according to the present invention, as mentioned above, includes two parts, that is, a color developing agent part solution and an alkali part processing solution. In a method of manufacturing the color developing agent part solution according to the present invention, in the case of the color developing agent is being supplied as an acid adduct in the raw material stage, after a neutralizing agent is added to an aqueous solution of the color developing agent and allowed reacting with at least one of the above-mentioned strong acid ion, the color developing agent solution is cooled and thereby the strong acid ion is precipitated and removed as a strong acid salt, and the developing agent solution is diluted with pure water.

As examples, methods as mentioned below can be cited.

(1) Dissolution of a color developing agents→ addition of a neutralizing agents addition of a solvent→ precipitation and removal of a strong acid salt in the color developing agent→ dilution, and

(2) Dissolution of a color developing agent→ addition of a solvent→ addition of a neutralizing agent→ precipitation and removal of a strong acid salt→ dilution.

Although the order of adding solvent is different in the above method (1) and method (2), as far as the solvent is added at an appropriate timing before and after the addition of the neutralizing agent, either method may be used, that is, the quality of the color developing agent part solution involving the present invention does not change.

When manufacturing according to the method (1) or method (2), a concentration of the color developing agent in dissolving step thereof is preferably set in the range of 0.2 mol/l to 2.3 mol/l. It is preferably set in the range of 0.5 mol/l to 2.0 mol/l, and more preferably from 0.6 mol/l to 1.8 mol/l. When thus setting, an appropriate concentration of the color developing agent can be obtained at the dilution. The concentration of the developing agent at the finishing time may be in the range of 0.2 mol/l to 2.0 mol/l, preferably from 0.5 mol/l to 2.0 mol/l, and more preferably from 1.05 mol/l to 1.8 mol/l.

Furthermore, a dissolution temperature of the color developing agent is set in the range of 0 degree centigrade to 80 degree centigrade, preferably from 20 degree centigrade to 70 degree centigrade, and more preferably from 20 degree centigrade to 40 degree centigrade.

As the antioxidant, sulfites may be added. An amount thereof to be added is, as the above sulfite, in the range of 0.0001 mol/l to 5 mol/l, preferably 0.0001 mol/l to 1.0 mol/l, and more preferably 0.005 to 0.5 mol/l. Thereby, a proper concentration of sulfurous acid can be obtained in the end.

Furthermore, as the neutralizing agent, the above-mentioned compounds are added. An amount of the neutralizing agent to be added can be in the range of 0.2 to 4.0 times by mole the color developing agent, preferably from 0.5 to 3.0 times, and more preferably from 0.7 to 2.2 times.

A temperature during the neutralization may be in the range of from 0 degree centigrade to 80 degree centigrade, preferably from 10 degree centigrade to 60 degree centigrade, and more preferably from 20 degree centigrade to 40 degree centigrade.

In the method of manufacturing the color developing solution according to the present invention, when the pH of the color developing agent part solution is set more than 7, vigorous reaction caused when the alkali solution is coated can be prevented from occurring. This is possible by adding the neutralizing agent to precipitate the strong acid salt, and thereby enabling to control the concentration of the strong acid ion.

The strong acid ion in the aqueous solution can be removed by filtering the aqueous solution after cooling. In the cooling step, a cooler may be used, or the aqueous solution may be left to stand for a predetermined period, for instance, three to five days. At this time, a cooling temperature is set in the range of −15 degree centigrade to 40 degree centigrade, preferably from −10 degree centigrade to 35 degree centigrade, and more preferably from −5 degree centigrade to 25 degree centigrade. By cooling, alkali metal sulfates, hydrochlorides or p-toluene sulfonates in the aqueous solution are precipitated.

Subsequently, precipitates are filtered and removed by using 0.22 μm to 10 μm membrane filer, filter fabric, or filter paper. Thereafter, by diluting with pure water, a proper developing agent concentration and a strong acid ion concentration are finally obtained.

In the above process, in the case of the color developing agent being not a generally-used acid adduct but so-called free color developing agent, the addition of the neutralizing agent and the precipitation and removal of the strong acid salt can be eliminated.

<Other Processing Solution>

The above-mentioned processing solution exhibits a further effect when undergoing the development process in combination with a processing solution described later. In addition, a processing solution containing one of the color developing solutions according to the present invention is most suitably processed according to a dry method. Although the back end processes respectively may be performed by means of coating, and also without saying impregnation in a processing bath may be performed in a conventional way.

Each of the processing solutions will be explained below.

A development stop solution is a processing solution used after the color development. The development stop solution stops a color developing reaction that uses the color developing solution according to the present invention speedily after a proper reaction is obtained, and thereby restrains the uneven development from occurring.

In the stop solution according to the present invention, a development inhibitor, chelating agent, pH buffering agent, and anticorrosion agent for SUS as shown below can be used.

As the development inhibitor, the development inhibitor such as halides (metal halides, ammonium halides), sulfurous acid and so on can be added.

As examples of the development inhibitor, alkali metal chlorides, bromides and iodides, benzimidazoles and benzthiazoles can be cited.

In addition, an amount thereof to be added may be in the range of 0.5 mol/l to 4 mol/l, preferably from 0.5 mol/l to 3.0 mol/l, and more preferably from1.0 mol/l to 2.0 mol/l. When an amount in such a range is added, an excessive color development reaction can be prevented from occurring. When an extremely high concentration of the development stop solution is used, it is likely that the development stop solution vigorously reacts with an alkali solution to cause bubbles. In the case of the next process being a fixing process, pH of a fixing solution is lowered, and thereby the fixing capability might be largely deteriorated.

As examples of the chelating agent, aminopolycarboxylic acid, aminopolyphosphonic acid, alkyl phosphonic acid and phosphonocarboxylic acid can be used.

Specifically, ethylenediamine tetraacetic acid, 1,2-propylenediamine tetraacetic acid, diet hylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, hydroxyethyl iminodiacetic acid, 1-hydroxyethylidene-1,1-diphosphonic acid, nitrilo-N,N,N-trimethylene phosphonic acid, ethylenediamine tetramethylene phosphonic acid and so on can be cited.

An amount of chelating agent to be added is preferably 5 g/l or less and more preferably 2 g/l or less.

Furthermore, the pH buffering agent can be added. As examples of the pH buffering agent, organic acids such as acetic acid, succinic acid, moronic acid, maleic acid, glutaric acid, and oxalic acid can be added. An amount to be added is in the range of 0 mol/l to 50 mol/l, and preferably from 0.1 mol/l to 2 mol/l.

Thus adjusted pH is preferably in the range of 1 to 6 and more preferably from 1 to 3.

Still furthermore, in order to prevent stainless of the processing tank from being corroded, as the anticorrosion agent, nitrates such as ammonium nitrate and sodium nitrate are used. A concentration of the nitrates is preferably in the range of from 0.3 mol/l to 4.0 mol/l and more preferably from 0.5 mol/l to 3.5 mol/l.

Furthermore, when the coating is applied, in order to prevent the processing solution from crystallizing or drying at the coating nozzle/head, as the anti-drying agent, two kinds or more of the anti-drying agents same as that used in the color developing agent part solution or the alkali part processing solution can be added.

Bleaching Solution

First, a composition of the bleaching solution will be explained.

As the bleaching solution according to the present invention, a bleaching solution containing a bleaching agent, bleaching accelerator, rehalogenating agent, pH buffering agent and other additives all of which are described below can be used.

As the bleaching agent, iron (III) aminopolycarboxylate, persulfuric acid and so on can be used. Specifically, iron (III) salts of ethylenediamine tetraacetic acid, 1,3-propanediamine tetraacetic acid, diethylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, ethylenediamine-N,N′-disuccinic acid, 1,3-propanediamine-N,N′-disuccinic acid, ethylenediamine-N,N′-dimalonic acid, 1,3-propanediamine-N,N′-dimalonic acid and so on can be used.

An amount of bleaching agent to be added is preferably in the range of 0.005 mol/l to 2 mol/l and more preferably from 0.01 mol/l to 1.0 mol/l.

Furthermore, in the bleaching solution according to the invention, the bleaching accelerators such as mercapto compounds, disulfide compounds and thiol compounds can be used.

Still furthermore, the rehalogenating agent may be added. For instance, alkali metal chlorides, bromides and iodides and ammonium salts such as ammonium chloride, ammonium bromide and ammonium iodide can be used.

An amount of the rehalogenating agent to be added is good to be 5 mol/l or less, preferably in the range of from 0.5 mol/l to 3.0 mol/l, and more preferably from 1.0 mol/l to 2.0 mol/l.

Furthermore, the chelating agent can be added. As examples thereof, aminopolycarboxylic acid, aminopolyphosphonic acid, alkyl phosphonic acid and phosphonocarboxylic acid can be used.

Specifically, ethylenediamine tetraacetic acid, 1,2-propylenediamine tetraacetic acid, diethylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, hydroxyethyl iminodiacetic acid, 1-hydroxyethylidene-1,1-diphosphonic acid, nitrilo-N,N,N-trimethylene phosphonic acid, ethylenediamine tetramethylene phosphonic acid and so on can be cited.

An amount of chelating agent to be added is preferably 20 mol percent or less of the bleaching agent.

Furthermore, as the pH buffering agent, organic acids such as acetic acid, succinic acid, moronic acid, maleic acid, glutaric acid, and oxalic acid can be used. An amount thereof to be added is in the range of 0 mol/l to 5 mol/l, and preferably from 0.1 mol/l to 2 mol/l.

Still furthermore, in order to prevent stainless of the processing tank from being corroded, as the anticorrosion agent, nitrates such as ammonium nitrate and sodium nitrate are used. A concentration of the nitrate is preferably in the range of from 0.3 mol/l to 4.0 mol/l and more preferably from 0.5 mol/l to 3.5 mol/l.

The pH of the processing solution (bleaching solution) used in the bleaching process is preferably in the range of 2 to 6 and more preferably from 3 to 5.

In the case of impregnating process being performed, an amount of the bleaching solution to be replenished in a continuous processing is preferably in the range of 25 ml/m² to 200 ml/m² of the photosensitive material.

A processing temperature may be in the range of 30 degree centigrade to 60 degree centigrade, preferably from 30 degree centigrade to 50 degree centigrade, and more preferably from 35 degree centigrade to 45 degree centigrade.

Furthermore, time period of processing is in the range of from 20 seconds to 3 minutes, preferably from 20 seconds to 1 minute and 30 seconds, and more preferably from 20 seconds to 1 minute.

In the case of the coating is performed, an amount to be coated is in the range of 1 ml/m² to 3000 ml/m², preferably from 5 ml/m² to 1000 ml/m², and more preferably from 10 ml/m² to 500 ml/m².

Furthermore, a processing temperature of the coating is in the range of from 25 degree centigrade to 70 degree centigrade, preferably from 30 degree centigrade to 65 degree centigrade, and more preferably from 40 to 60 degree centigrade.

The time period for processing may be same as that in the impregnating process.

In the case of the coating being performed, the coating may be performed a plurality of times. The times of coating may be in the range of from 1 time to 20 times, preferably from 1 time to 12 times, and more preferably from 1 time to 5 times.

Furthermore, in the case of the coating being performed, when the coating is not in the process, the coating solution crystallizes and dries at the coating nozzle and head, and thereby when the coating is restarted, the coating failure results. In order to prevent the coating failure from occurring, the anti-drying agent that is used in the color developing process can be used.

In this case, an amount to be added is in the range of 1 w/v percent to 50 w/v percent, preferably 1 w/v percent to 40 w/v percent, and more preferably from 2 w/v percent to 30 w/v percent.

Furthermore, in order to uniformly coat on the photosensitive material, the surface tension adjusting agent same as that added to the color developing solution can be added. In this case, the surface tension of the processing solution after the adjusting agent is added is preferably in the range of from 25 mN/m to 72 mN/m (measurement temperature 25 degree centigrade to 50 degree centigrade), and more preferably from 25 mN/m to 50 mN/m (measurement temperature 25 degree centigrade to 50 degree centigrade).

Still furthermore, in order for the processing solution not to overflow after being coated on the photosensitive material, the viscosity adjusting agent same as that added to the color developing solution can be added. In this case, the viscosity of the processing solution after the adjusting agent is added is preferably 30000 cp or less (measurement temperature in the range of 25 degree centigrade to 50 degree centigrade), and more preferably from 0.5 cp to 5000 cp (measurement temperature in the range of 25 degree centigrade to 50 degree centigrade).

Fixing Solution

In the next place, the fixing solution according to the present invention will be explained.

As the fixing solution according to the invention, a fixing solution containing a fixing agent, stabilizing agent, chelating agent and other additives that are shown below is used.

As the fixing agent, thiosulfates such as ammonium thiosulfate and sodium thiosulfate are preferably used. Furthermore, two kinds or more of other known fixing agents, that is, thiocyanates such as sodium thiocyanate, potassium thiocyanate, ammonium thiocyanate and so on, thioether compounds such as ethylene bis(thioglycol) and so on and thiourea may be used.

An amount of the fixing agent to be added is in the range of 0.01 mol/l to 5.0 mol/l, preferably from 0.1 mol/l to 3.0 mol/l, and more preferably from 0.5 mol/l to 2.0 mol/l.

As the stabilizing agent, sulfites such as ammonium sulfite, potassium sulfite and sodium sulfite, bisulfites such as ammonium bisulfite, potassium bisulfite and sodium bisulfite, metabisulfites such as ammonium metabisulfite, potassium metabisulfite and sodium metabisulfite, hydroxyl amines, reductones such as ascorbic acid and so on and sulfinic acids can be used as needs arise.

These stabilizing agents are used in the range of from 0.001 mol/l to 1.5 mol/l, preferably from 0.0 mol/l to 0.5 mol/l, and more preferably from 0.0 mol/l to 0.25 mol/l.

As the chelating agent, aminopolycarboxylic acid, aminopolyphosphonic acid, alkyl phosphonic acid and phosphonocarboxylic acid can be used.

Specifically, ethylenediamine tetraacetic acid, 1,2-propylenediamine tetraacetic acid, diethylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, hydroxyethyl iminodiacetic acid, 1-hydroxyethylidene-1,1-diphosphonic acid, nitrilo-N,N,N-trimethylene phosphonic acid, ethylenediamine tetramethylene phosphonic acid and so on can be cited.

Furthermore, an amount of chelating agent to be used is preferably in the range of from 0.1 g/l to 5 g/l.

Still furthermore, the pH buffering agents having the pKa in the range of 5 to 9 can be preferably added. Thereby, the fixing agent can be inhibited from being decomposed and sulphidized.

As examples of such compound, the following compounds can be cited. That is, ethylenediamine (pKa 7.47), N-methylethylenediamine (pKa 7.56), N-ethylethylenediamine (pKa 7.63), N-n-propylethylenediamine (pKa 7.54), N-isopropylethylenediamine (pKa 7.70), N-(2-hydroxyethyl)ethylenediamine (pKa 7.21), N,N-dimethylethylenediamine (pKa 6.79), N,N-diethylethylenediamine (pKa 7.07), N,N′-dimethylethylenediamine (pKa 7.47), N,N′-diethylethylenediamine (pKa 7.77), N,N′-di-n-propylethylenediamine (pKa 7.53), N,N′-di(2-hydroxylethyl)ethylenediamine (pKa 7.18), N,N,N′,N′-tetramethylethylenediamine (pKa 6.56), 1,2-diaminopropane (pKa 7.13), meso-2,3-diaminopropane (pKa 6.92), triethylenetetramine (pKa 6.67), 1,2,3-triaminopropane (pKa 7.95), 1,3-diamino-2-aminomethylpropane (pKa 6.44) and so on.

Furthermore, aminopyridine type compounds having the acid dissociation constant (pKa) in the range of 5.5 to 8.5 may be used. Ones having the pKa in the range of 6.3 to 7.8 are preferable. This is because when pKa is 5.5 or less, pH of the processing solution is lowered and thereby the dissociation of thiosulfate is accelerated. On the other hand, when the pH is 8.5 or more, the bleaching capability deteriorates. Specifically, compounds such as 2-aminopyridine (pKa 6.78), 3-aminopyridine (pKa 6.06) and so on can be cited.

Still furthermore, compounds having general formulas [V], [VI] and [VII] below can preferably be used.

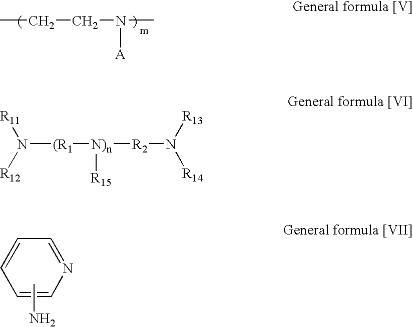

In the general formula [VI], R1 and R2 each independently represent a straight chain alkylene group or branched alkylene group and may be substituted by an amino group, alkylamino group, sulfo group or hydroxyl group. “n” represents a number from 0 to 8. R11, R12, R13, R14 and R15, respectively, represent a hydrogen atom or straight chain alkyl group with 1 to 4 carbon atoms or branched alkyl group with 1 to 4 carbon atoms (it may be substituted by an amino group, alkylamino group, sulfo group or hydroxyl group), acyl group, aryl group or hydroxyl group. Furthermore, R11 and R12, R12 and R15, R15 and R14, R14 and R13, R11 and R13, and R12 and R14, respectively, may form a heterocycle in combination or a combined bis body. All of the amino groups contained in the formula [VI] are not necessarily a tert-amine.

In the formula [V], A denotes a hydrogen atom or hydroxyl group. Furthermore, m denotes a number from 4 to 360.

Other than the above compounds, imidazole and imidazole derivatives may be added.

An amount of these pH buffering agents to be added is preferably in the range of from 0.0001 mol/l to 5 mol/l.

By thus controlling the pH, the pH of the fixing solution is preferably controlled in the range of from 5 to 10 and more preferably from 6 to 9.

Furthermore, a development stop agent can be added. By thus performing, after the color developing process, the developing process can be speedily stopped, resulting in accelerating the processing.

As compounds to be added, nitrogen-containing heterocyclic compounds such as benzotriazole, 6-nitrobenzimidazole, 5-nitroisoindazole, 5-methyl benzotriazole, 5-nitrobenzotriazole, 5-chloro-benzotriazole, 2-thiazoryl-benzimidazole, 2-thiazorylmethyl-benzimidazole, indazole, hydroxyazaindolizine, and adenine; 1-phenyl-5-mercaptotetrazole; alkali metal chlorides, bromides and iodides; and ammonium salts such as ammonium chloride, ammonium bromide, ammonium iodide can be used. Alkali metal bromides and iodides, ammonium salts such as ammonium bromide and ammonium iodide, and 1-phenyl-5-mercaptotetrazole are preferable.

An amount to be added is in the range of from 0.001 mol/l to 1 mol/l and preferably from 0.005 mol/l to 0.5 mol/l.

When the impregnation is applied, a replenishment amount is in the range of from 250 ml/m² to 1400 ml/m², and a processing temperature is in the range of from 30 degree centigrade to 60 degree centigrade, preferably from 30 degree centigrade to 50 degree centigrade, and more preferably from 35 degree centigrade to 50 degree centigrade.

When the coating is applied, a coating amount is in the range of from 1 ml/m² to 3000 ml/m², preferably from 5 ml/m² to 1000 ml/m², and more preferably from 10 ml/m² to 500 ml/m².

Furthermore, a processing temperature is in the range of from 25 degree centigrade to 70 degree centigrade, preferably from 30 degree centigrade to 65 degree centigrade, and more preferably from 40 degree centigrade to 60 degree centigrade.

The coating may be repeated a plurality of times, preferably from 1 time to 12 times, and more preferably from 1 time to 5 times.

A processing time period for both impregnation and coating may be in the range of from 5 seconds to 5 minutes, preferably from 10 seconds to 2 minutes and 30 seconds, and more preferably from 10 seconds to 2 minutes.

Furthermore, when the coating is applied, in order to prevent the coating failure from occurring because the processing solution crystallizes or dries at the coating nozzle/head during the suspension of the processing, as the anti-drying agent, the anti-drying agents that were used in the color developing process may be added. In this case, two kinds or more of the anti-drying agents can be added. Thereby, the coating unevenness when the coating is restarted can be prevented.

An amount thereof to be added may be in the range of from 1 w/v percent to 50 w/v percent, preferably from 1 w/v percent to 40 w/v percent, and more preferably 2 w/v percent to 30 w/v percent.

Furthermore, in order to uniformly coat on a photosensitive material, a surface tension adjusting agent same as that that is added to color developing solution may be added. In this case, the surface tension of the processing solution after the addition of the adjusting agent is preferably from 25 mN/m to 72 mN/m (measurement temperature in a range of 20 degree centigrade to 50 degree centigrade) and more preferably from 25 mN/m to 50 mN/m (measurement temperature in a range of 20 degree centigrade to 50 degree centigrade).

Still furthermore, in order for the processing solution not to overflow after it is coated on the photosensitive material, the viscosity adjusting agent same as that added to the color developing solution can be added. In this case, the viscosity of the processing solution after the adjusting agent is added is preferably 30000 cp or less (measurement temperature in a range of 25 degree centigrade to 50 degree centigrade), and more preferably from 0.5 cp to 5000 cp (measurement temperature in a range of 25 degree centigrade to 50 degree centigrade).

Bleaching-Fixing Solution

The bleaching-fixing solution performs the above-mentioned bleaching process and fixing process in one processing solution.

In the bleaching-fixing solution, as a bleaching agent, iron (III) aminopolycaroxylate, persulfuric acid and so on can be used. In the bleaching solution, an iron complex previously formed as a ferric complex may be used, alternatively ferric sulfate, iron (III) nitrate, ferric chloride or the like and a complex forming compound may be allowed coexisting in the bleaching solution to form a complex in the solution.

As specific examples of aminopolycarboxylic acids, ethylenediamine tetraacetic acid, 1,3-propylenediamine tetraacetic acid, diethylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, ethylenediamine-N, N′-disuccinic acid, 1,3-propanediamine-N, N′-disuccinic acid, ethylenediamine-N, N′-dimalonic acid, 1,3-propanediamine-N, N′-dimalonic acid and so on can be cited.

In the next place, as a fixing agent in the bleaching-fixing solution, thiosulfates such as ammonium thiosulfate, sodium thiosulfate can be preferably used. Furthermore, two kinds or more of other known fixing agents, namely, thiocyanates such as sodium thiocyanate, potassium thiocyanate, ammonium thiocyanate and so on, thioether compounds such as ethylene bis(thioglycol) and so on and thiourea may be used in combination.

An amount of the fixing agent to be added is in the range of from 0.1 mol/l to 5 mol/l, preferably from 0.1 mol/l to 3 mol/l, and more preferably from 0.5 mol/l to 2 mol/l.

As bleaching-fixing accelerators that are used in the bleaching-fixing solution, for instance, mercapto compounds, disulfide compounds and thiol compounds can be cited.

Specifically, 3-mercapto-1,2,4-triazole, diethylaminoethanethiol and so on can be cited.

As the stabilizing agent, sulfites such as ammonium sulfite and sodium sulfite, bisulfites such as ammonium bisulfite and potassium bisulfite, metabisulfites such as ammonium metabisulfite and potassium metabisulfite, hydroxyl amines, reductones such as ascorbic acid and so on and sulfinic acids can be used as needs arise.

An amount of the stabilizing agent to be used is in the range of 0.005 mol/l to 3.0 mol/l, preferably from 0.005 mol/l to 2.0 mol/l, and more preferably from 0.005 mol/l to 1.0 mol/l.

As the chelating agent, aminopolycarboxylic acid, aminopolyphosphonic acid, alkyl phosphonic acid and phosphonocarboxylic acid can be used.

Specifically, ethylenediamine tetraacetic acid, 1,2-propylenediamine tetraacetic acid, diethylenetriamine pentaacetic acid, 1,2-cyclohexanediamine tetraacetic acid, iminodiacetic acid, methyl iminodiacetic acid, nitrilotriacetic acid, hydroxymethyl iminodiacetic acid, N-(2-carboxyethyl)iminodiacetic acid, N-(2-carboxymethyl)iminodiacetic acid, β-alaninediacetic acid, hydroxyethyl iminodiacetic acid, 1-hydroxyethylidene-1,1-diphosphonic acid, nitrilo-N,N,N-trimethylene phosphonic acid, ethylenediamine tetramethylene phosphonic acid and so on can be cited.

An amount of chelating agent to be added is preferably in the range of from 0.0001 mol/l to 5 mol/l.

Furthermore, in order to prevent the fixing agent from decomposing and sulphidizing, the pH buffering agents having the pKa in the range of 5 to 9 may be added.

As examples of such compounds, the following compounds can be cited. ethylenediamine (pKa 7.47), N-methylethylenediamine (pKa 7.56), N-ethylethylenediamine (pKa 7.63), N-n-propylethylenediamine (pKa 7.54), N-isopropylethylenediamine (pKa 7.70), N-(2-hydroxyethyl)ethylenediamine (pKa 7.21), N,N-dimethylethylenediamine (pKa 6.79), N,N-diethylethylenediamine (pKa 7.07), N,N′-dimethylethylenediamine (pKa 7.47), N,N′-diethylethylenediamine (pKa 7.77), N,N′-di-n-propylethylenediamine (pKa 7.53), N,N′-di(2-hydroxylethyl)ethylenediamine (pKa 7.18), N,N,N′,N′-tetramethylethylenediamine (pKa 6.56), 1,2-diaminopropane (pKa 7.13), meso-2,3-diaminopropane (pKa 6.92), triethylenetetramine (pKa 6.67), 1,2,3-triaminopropane (pKa 7.95), 1,3-diamino-2-aminomethylpropane (pKa 6.44) and so on.

Furthermore, aminopyridine type compounds having the acid dissociation constant (pKa) in the range of from 5.5 to 8.5 may be used. Ones having the pKa in the range of from 6.3 to 7.8 are preferable. This is because when the pKa is 5.5 or less, the pH of the processing solution is lowered and thereby the dissociation of thiosulfate is accelerated; on the other hand, when the pH is 8.5 or more, the bleaching capability is deteriorated. Specifically, compounds such as 2-aminopyridine (pKa 6.78), 3-aminopyridine (pKa 6.06) and so on can be cited.

Still furthermore, compounds having general formulas [V], [VI] and [VII] described in the fixing solution can be used.

Furthermore, imidazole, imidazole derivatives, or organic acids such as acetic acid, succinic acid, malonic acid, maleic acid, glutaric acid and oxalic acid may be used.

An amount of the pH buffering agent to be added is preferably in the range of from 0.0001 mol/l to 5 mol/l.

Furthermore, the pH of thus obtained bleaching-fixing solution is preferably in the range of from 4 to 9.

The bleaching-fixing process according to the invention may be performed according to either method of the impregnating method and the coating method.

When the impregnation is applied, an amount of the bleaching-fixing solution to be replenished may be in the range of from 5 ml/m² to 216 ml/m², preferably from 5 ml/m² to 70 ml/m², and more preferably from 5 ml/m² to 35 ml/m².

A processing temperature is in the range of from 30 degree centigrade to 60 degree centigrade, preferably from 30 degree centigrade to 50 degree centigrade, and more preferably from 35 degree centigrade to 45 degree centigrade.

A processing time period may be in the range of from 20 seconds to 3 minutes, preferably from 20 seconds to 2 minutes and 30 seconds, and more preferably from 20 seconds to 2 minutes.

When the coating is applied, an amount of the bleaching-fixing solution to be coated may be in the range of from 1 ml/m² to 3000 ml/m², preferably from 5 ml/m² to 1000 ml/m², and more preferably from 10 ml/m² to 500 ml/m².

Furthermore, a processing temperature is in the range of from 25 degree centigrade to 70 degree centigrade, preferably from 30 degree centigrade to 65 degree centigrade, and more preferably from 40 degree centigrade to 60 degree centigrade.

A time period for processing is arbitrary in the range of from 3 seconds to 5 minutes, preferably from 5 seconds to 2 minutes, and more preferably from 5 seconds to 1 minute and 20 seconds.

The coating may be repeated a plurality of times, preferably from 1 to 12 times, and more preferably from 1 to 5 times.

Furthermore, similarly to the color developing process, in the case of the coating being applied, an anti-drying agent, surface tension adjusting agent and viscosity adjusting agent can be added. Amounts of these to be added are identical to that in the color developing process.

Washing and/or Stabilizing Solution

As a washing and/or stabilizing solution according to the invention, as a substitute for water washing, a rinse solution containing, in place of a large amount of washing water, a chemical rinse agent, anti-waterdrop agent, anti-microbial agent, chelating agent, pigment stabilizing agent and so on can be used. Washing water and the rinse solution may be used in combination, or the rinse solution alone may be used.

As the anti-waterdrop agent, surfactants can be used. In particular, nonionic surfactants is preferably used.

Furthermore, in order to inhibit bio-slime from occurring in a processing tank and microbe from occurring in a photosensitive material after the processing, an anti-microbial agent may be contained. Ordinarily, an amount of the anti-microbial agent to be added is in the range of from 0.01 to 0.1 g/l; however, when the processing agent according to the present invention is added to the processing solution in the washing and/or stabilizing process, an amount of the anti-microbial agent to be added can be increased up to 10 times the ordinary amount of the anti-microbial agent to be used.

As specific anti-microbial agents, the followings can be cited.

That is, alcoholic anti-microbial agents such as ethanol, propanol, isopropyl alcohol, 2-bromo-2-nitro-propanol, N-(2-hydroxypropyl)-aminoethanol and so on; phenolic anti-microbial agents such as 3-Methyl-4-isopropylphenol, thymol, o-phenylphenol, methylphenol, para-chlorophenol, chlorophene, 2,4,6-tribromophenol and so on; aldehyde type anti-microbial agents such as formaldehyde, glutaraldehyde, benzaldehyde, α-bromocinnamaldehyde; carboxylic acid type anti-microbial agents such as benzoic acid and derivatives thereof, undecylenic acid metal complexes, undecylenic acid ethanolamide, propionic acid, caprylic acid, sorbic acid; ester type anti-microbial agents such as p-hydroxybenzoates (paraben), aliphatic monoglycerides and so on; ether type anti-microbial agents such as 2,4,4′-trichloro-2′-hydroxydiphenyl ester; nitrile type anti-microbial agents such as tetrachloroisophthalonitrile; peroxide type anti-microbial agents such as hydrogen peroxide, peracetic acid, ethylene oxide, propylene oxide; halogen type anti-microbial agents such as p-chlorophenyl-3-iodopropargyl formal, dichlofluanide, chlorinated isocyanuric acid, 2-bromo-2-nitro-1,3-propanediol; pyridine and quinoline type anti-microbial agents such as 8-oxyquinoline, 2,3,5,6-tetrachloropyridine derivatives; triazine type anti-microbial agents such as N,N′,N″-trishydroxymethylhexahydro-S-triazine; isothializone type anti-microbial agents such as 5-chloro-2-methyl-4-isothiazoline-3-on, 2-methyl-4-isothiazoline-3-on, benzoisothializone derivatives and so on; imidazole/thiazole type anti-microbial agents such as thiobendazole derivatives, benzoisothiazole derivatives; anilide type anti-microbial agents such as chlorocarbanilide derivatives; biguanide type anti-microbial agents such as cyclohexydine gluconate, chlorohexydine hydrochloride, polyhexamethylenebiguanidine hydrochloride; dithiocarbamate type anti-microbial agents such as alkyl dithiocarbamate derivatives; disulfide type anti-microbial agents such as dithio-2-2′-bisbenzamide; glucide type anti-microbial agents such as chitosan, polyglucosamine, aminoglycoside; tropolone type anti-microbial agents such as natural hinokithiol; surfactant type anti-microbial agents such as octadecylamine acetate, alkyldiaminoethyl glycine, polyoxyalkylene ammonium, benzalkonium chloride; and organometallic compound type anti-microbial agents such as 8-oxyquinoline metal complex, metal complexes of glutamic acid derivatives, metal complexes of naphtenic acid.

Among the above compounds, anti-microbial agents such as alcoholic anti-microbial agents, carboxylic acid type anti-microbial agents, ester type anti-microbial agents, halogen type anti-microbial agents, isothiazoline type anti-microbial agents, disulfide type anti-microbial agents, surfactant type anti-microbial agents, p-chlorophenyl-3-iodopropargyl formal dichloramide and 2-bromo-2-nitro-1,3-propanediol are preferable in view of suppressing the bio-slime from occurring and the yellow stain from rising and of preserving images. Furthermore, anti-microbial agents such as formaldehyde, ester type anti-microbial agents, p-chlorophenyl-3-iodopropargyl formal dichloramide, 2-bromo-2-nitro-1,3-propanediol and the disulfide type anti-microbial agents are more preferable.

Two or more kinds of the abovementioned anti-microbial agents may be used in combination in the stabilizing solution.

Furthermore, together with the above anti-microbial agents, an antibacterial method and an eradication method shown below may be used in combination.

A silver type compound in which an insoluble zirconium phosphate type compound or silver is carried by an inorganic compound, an antibacterial zeolite in which a metal ion of such as copper, zinc, silver or the like is carried by zeolite, and a processing tank, a roller or a filter that uses antibacterial ceramic may be used in combination.

Furthermore, a generally used antibacterial method such as a UV lamp, ultra-sonic vibration, or energizing process may be used in combination. Still furthermore, an antibacterial method that uses an antibacterial filter may be used together.

As the image stabilizing agent, formalin, aldehydes or methylol urea, or formalin releasing compounds such as hexamethylenetetramine and so on can be used.

An amount of the image stabilizing agent to be added is preferably in the range of from 0.0001 mol/l to 0.01 mol/l.

Furthermore, in order to inhibit dust from adhering, after drying, the photosensitive material owing to static electricity, anti-static agents such as dioctyl ether of sulfosuccinic acid, sodium lauroyl sarcosine, distearyl dimethyl ammonium chloride and so on, triazinylstilbene type fluorescent whitening agents or the like may be contained.

Still furthermore, organic solvents such as diethylene glycol, ethanol, ethylene glycol, N-methyl-2-pyrholidone, butyl cellosolve, γ-butylolactone, triethanolamine and so on can be used.

Furthermore, as the chelating agents, aminopolycarboxylic acid, alkyl phosphonic acid, alkyl sulfonic acid and phosphonocarboxylic acid may be added.

An amount of the chelating agent to be added is in the range of from 0.00001 mol/l to 0.2 mol/l and preferably from 0.00001 mol/l to 0.02 mol/l.

Furthermore, in order to prevent the fixing agent from decomposing, at least one kind or more of the following compounds (a), (b) and (c) represented by the general formulas [V], [VI] and [VII] described in the fixing solution, or sulfites or bisulfites are preferably contained as the stabilizing agent.

(a) Compounds represented by the following general formula [VI],

(b) aminopyridine type compounds represented by the following general formula [VII] and

(c) polyethylene imines represented by the following general formula [V].

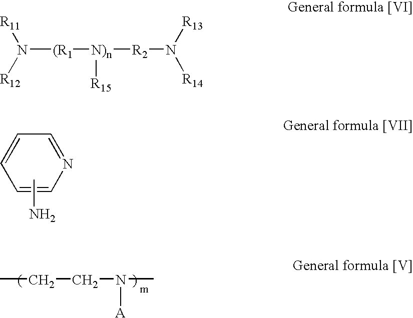

Now, when the compound (a) or (b) is used, it is preferably used in the washing and/or stabilizing process, respectively, in the range of from 0.0001 mol/l to 1 mol/l, and more preferably from 0.0002 mol/l to 0.1 mol/l.

Furthermore, when the compound (c) is used, it is preferably used in the washing and/or stabilizing process, respectively, in the range of 0.00001 mol/l to 0.3 mol/l, and more preferably from 0.00005 mol/l to 0.1 mol/l.

In the case of sulfite or bisulfite being added, an amount of sulfite or bisulfite to be added is preferably in the range of from 0.0004 mol/l to 2 mol/l, and more preferably from 0.0008 mol/l to 0.16 mol/l.

Furthermore, in order to adjust the pH, a pH buffering agent may be added.

In order to maintain the pH of the stabilizing solution within a certain range, organic acids such as acetic acid, propionic acid, succinic acid, maleic acid, glycine, taurine, glycolic acid and so on may be used as the pH buffering agent. In particular, the buffering agents (compounds having the pKa in the range of from 4 to 8) having the buffer capacity in the range of from pH4 to 8 are preferable.

Furthermore, the pH of the rinse solution is preferably in the range of from 3 to 9, and more preferably from 4 to 8.

As the processing method, similarly to the above processes, either of the impregnation method and the coating method can be used.

In the case of the impregnation being applied, a replenishment amount of the stabilizing solution tank in the continuous processing is preferably from 25 to 2500 ml/l per m² of the photosensitive material, and more preferably from 150 to 1800 ml/l.

The processing temperature is preferably in the range of from 30 degree centigrade to 45 degree centigrade. Furthermore, the processing time period is preferably in the range of from 15 seconds to 10 minutes, and particularly preferably from 30 seconds to 5 minutes.

As to a stabilizing processing solution tank according to the invention, an arbitrary system such as a single tank system, multistage counterflow cascade system, or multistage parallel flow system may be adopted; however, the multistage counterflow cascade system is preferable.

In the multistage counterflow cascade system, ordinarily, there are two or more stabilizing solution tanks. In the system, the solution replenished into the last tank overflows therefrom, thereby sequentially flows in former tanks, and a waste solution is exhausted from the foremost tank. In this case, since the processing solution is flowed in a direction opposite to a processing direction of the photosensitive material, a salt concentration in the last tank becomes lowest and salts in the photosensitive material can be washed with progressively cleaner processing solution. Accordingly, a small amount of the processing solution can remove the salts in the photosensitive material similarly to the case of running water washing. Furthermore, the number of the processing tank is preferably from 3 to 8.

In the next place, in the case of the coating, a coating amount may be in the range of from 1 ml/m² to 3000 ml/m², preferably from 5 ml/m² to 500 ml/m², and more preferably from 10 ml/m² to 300 ml/m².

A processing temperature may be in the range of from 10 degree centigrade to 70 degree centigrade, preferably from 30 degree centigrade to 65 degree centigrade, and more preferably from 40 degree centigrade to 60 degree centigrade.

Furthermore, a time period for processing may be in the range of from 10 seconds to 5 minutes, preferably from 10 seconds to 2 minutes, and more preferably from 10 seconds to 1 minute and 20 seconds.

The coating may be repeated in the range of from 1 time to 20 times, preferably from 1 time to 12 times, and more preferably from 1 time to 5 times.

Furthermore, in the case of the coating being applied, in order to inhibit the processing solution from drying or crystallizing at the coating nozzle/head and to uniformly coat on the photosensitive material, similarly to the above processes, the anti-drying agent, surface tension adjusting agent and viscosity adjusting agent can be preferably added.

A processing method according to the invention will be explained below.

The processing method according to the present invention is a processing method of a silver halide color photographic photosensitive material including a color developing process. The color developing process has a step of processing a color developing agent part solution and a step of processing an alkali part processing solution. The processing is performed by use of the coating or impregnation and may be the same or different in the respective steps of the color developing agent part solution and alkali part solution.

That is, after, in the color developing process, a photosensitive material is developed by use of a color developing solution that is divided into two, in subsequent back end processes, silver formed in the development is oxidized and dissolved in the desilvering step, and washed and removed in the washing step or washed in the stabilizing step containing the anti-microbial agent and the stabilizing agent of the pigment, and thereby a series of steps are carried out. Furthermore, ordinarily after the washing step, a drying step for drying the processed photosensitive material may be provided. Still furthermore, according to the processing method according to the present invention, after these processing steps, in the image processing step, the photosensitive material is read with a scanner to process the image.

The desilvering step fundamentally has a bleaching step in which the silver formed in the development is oxidized with a bleaching solution and a fixing step in which the oxidized silver is converted into a silver salt dissolvable in the fixing solution. The bleaching step and the fixing step can be separately performed with corresponding bleaching solution and fixing solution; however, with a bleaching-fixing solution in which a bleaching solution and a fixing solution are mixed and thereby the bleaching and the fixing can be simultaneously carried out, the bleaching step and the fixing step may be integrated (bleaching-fixing step).

Furthermore, depending on the processing step, the bleaching step, the fixing step and the bleaching-fixing step each may be appropriately combined; that is, after for instance the bleaching or fixing step is performed, the bleaching-fixing step with the bleaching-fixing solution may be provided. Furthermore, without performing the back end processes, the image processing can be performed. That is, for the processing method according to the invention, specifically, the following procedures can be illustrated. However, the processing method according to the invention is not restricted thereto.

1) Color development-bleaching-fixing-washing (stabilizing)-drying-scanning (image processing),

2) color development-bleaching-fixing-washing (stabilizing)-scanning (image processing),

3) color development-bleaching-fixing-drying-scanning (image processing),

4) color development-bleaching-fixing-scanning (image processing),

5) color development-fixing-bleaching-washing (stabilizing)-drying-scanning (image processing),

6) color development-fixing-bleaching-washing (stabilizing)-scanning (image processing),

7) color development-fixing-bleaching-drying-scanning (image processing),

8) color development-fixing-bleaching-scanning (image processing),

9) color development-fixing-washing (stabilizing)-drying-scanning (image processing),

10) color development-fixing-washing (stabilizing)-scanning (image processing),

11) color development-fixing-drying-scanning (image processing),

12) color development-fixing-scanning (image processing),

13) color development-bleaching-washing (stabilizing)-drying-scanning (image processing),

14) color development-bleaching-washing (stabilizing)-scanning (image processing),

15) color development-bleaching-drying-scanning (image processing),

16) color development-bleaching-scanning (image processing),

17) color development-bleaching/fixing-washing (stabilizing)-drying-scanning (image processing),

18) color development-bleaching/fixing-washing (stabilizing)-scanning (image processing),

19) color development-bleaching/fixing-drying-scanning (image processing),

20) color development-bleaching/fixing-scanning (image processing),

21) color development-washing (stabilizing)-drying-scanning (image processing),

22) color development-washing (stabilizing)-scanning (image processing),

23) color development-drying-scanning (image processing), and

24) color development-scanning (image processing).

Among these, procedures according to 1) through 20) are preferable and procedures according to 1), 2), 4) through 6), 9), 10) and 12) are more preferable.

As mentioned above, when the back end processes are provided after the color developing step, the transmittance of the photosensitive material can be improved; accordingly, the scanning can be completed in a shorter time, that is, the so-called scanning aptitude can be improved.

In the processing method according to the present invention, although in the color developing step, the processing solution is directly coated on or impregnated in the photosensitive material, also in the subsequent steps the existing impregnation or coating method may be applied.

Furthermore, between the respective steps, squeezing may be applied to scrape the processing solution remained on the photosensitive material (squeezing step). Thereby, the permeability of a processing solution to be subsequently coated can be increased. Still furthermore, in the case of the impregnation being applied, the processing solution can be inhibited from being carried in the subsequent tank, resulting in improving also processing efficiency.

### EMBODIMENTS

In the following, the present invention will be detailed with reference to embodiments. However, the present invention is not restricted to the following embodiments.

### <MANUFACTURING EXAMPLE>

### <Manufacturing Example of Color Developing Agent Part Solution>

CD-4:

### (4-amino-3-methyl-N-ethyl-N-(2-hydroxyethyl)aniline monosulfate

Manufacturing Method 1

Dissolution of developing agent:

| | |
|---|---|
| 4-amino-3-methyl-N-ethyl-N-(2-hydroxyethyl)aniline | 1.30 mol |
| monosulfate | |

Agitation by use of a magnetic stirrer under room temperature

| | | |
|---|---|---|
| Potassium bisulfite | 1.05 | mol |
| Deionized water | 615 | ml |

Manufactured by use of a high-purity water production apparatus: Cartridge type high-purity water production apparatus G-101 C manufactured by Organo Corporation

| | | |
|---|---|---|
| N-methyl-2-pyrohlidone | 1.11 | mol |
| Diethylene glycol | 1.03 | mol |
| Amount of finished solution | 1077 | ml |
| Neutralization: KOH (flake) | 2.54 | mol |

Gradually adding the KOH and controlling a temperature to 40 degree centigrade or less with a water bath.

Crystallization: leaving for 15 minutes or more at temperature equal to 15 degree centigrade or less.

Removal: removing potassium sulfate by suction filtering by use of a 5C filter paper (retention particle diameter of 1 μm)

An amount of solution after the removal is made 1000 ml (1.30 mol/l as CD-4)

The pH at the finishing time: 7.2

Confirmation of sulfate ion concentration: it was confirmed that the sulfate ion was not detected by analyzing by ion chromatography

Removal rate 100 percent: molar ratio with respect to the developing agent being 0.0

Confirmation of CD-4 concentration: CD-4 was confirmed to be 1.30 mol/l by liquid chromatography

Manufacturing Method 2

Dissolution of developing agent:

| | | |
|---|---|---|
| 4-amino-3-methyl-N-ethyl-N-(2-hydroxyethyl)aniline | 0.50 | mol |
| monosulfate | | |
| Potassium bisulfite | 0.42 | mol |
| Deionized water | 833 | ml |
| These were agitated by use of a magnetic stirrer. | | |
| N-methyl-2-pyrohlidone | 0.44 | mol |
| Diethylene glycol | 0.41 | mol |
| T.S. | 1075 | ml |

Neutralization: Gradually adding 0.82 mol KOH (flake) followed by controlling to temperature equal to 40 degree centigrade or less with a water bath.

Crystallization: Leaving for 15 minutes or more at equal to 15 degree centigrade or less.

Removal: Potassium sulfate was removed by suction filtering with a 5C paper filter (retention particle diameter: 1 μm).

Amount of solution after the removal: Adjusted to 1000 ml (0.50 mol/l as CD-4)

The pH at the finishing time was adjusted to 7.2.

Confirmation of sulfate ion concentration: It was confirmed by analyzing by ion chromatography that the sulfate ion concentration was 0.10 mol/l and the removal ratio was 80 percent, that is, a molar ratio with respect to the developing agent was 0.20.

Confirmation of the CD-4 concentration: It was confirmed by liquid chromatography that the CD-4 was 0.50 mol/l.

Manufacturing Method 3

Dissolution of developing agent:

| | | |
|---|---|---|
| 4-amino-3-methyl-N-ethyl-N-(2-hydroxyethyl)aniline | 0.20 | mol |
| monosulfate | | |
| Potassium bisulfite | 0.17 | mol |
| Deionized water | 956 | ml |

These were agitated by use of a magnetic stirrer under room temperature.

| | | |
|---|---|---|
| N-methyl-2-pyrohlidone | 0.18 | mol |
| Diethylene glycol | 0.16 | mol |
| T.S. | 1070 | ml |
| Neutralization: KOH (flake) | 0.40 | mol |

After these were gradually added, temperature was controlled to 40 degree centigrade or less with a water bath.

Crystallization: Left for 15 minutes or more at temperature equal to 15 degree centigrade or less.

Removal: Potassium sulfate was removed by suction filtering with a 5C paper filter (retention particle diameter: 1 μm)

Amount of solution after the removal was adjusted to 1000 ml (0.20 mol/l as CD-4).

The pH at the finishing time was adjusted to 8.0.

Confirmation of sulfate ion concentration: It was confirmed by analyzing by ion chromatography that the sulfate ion concentration was 0.10 mol/l and the removal ratio was 50 percent, that is, a molar ratio with respect to the developing agent was 0.5.

Confirmation of the CD-4 concentration: It was confirmed by analyzing by liquid chromatography that the CD-4 was 0.20 mol/l.

Manufacturing Method 4

Dissolution of developing agent:

| | | |
|---|---|---|
| 4-amino-3-methyl-N-ethyl-N-(β-methanesulfonamideethyl) | 0.74 | mol |
| aniline 1.5 sulfate) | | |
| Potassium bisulfite | 0.91 | mol |
| Deionized water | + | |

These were agitated by use of a magnetic stirrer under room temperature.

| | | |
|---|---|---|
| N-methyl-2-pyrohlidone | 0.95 | mol |
| Diethylene glycol | 0.89 | mol |
| T.S. | 1160 | ml |
| Neutralization: KOH (flake) | 1.83 | mol |

These were gradually added and temperature was controlled to 40 degree centigrade or less with a water bath.

Crystallization: Left for 15 minutes or more at temperature equal to 15 degree centigrade or less.

Removal: Potassium sulfate was removed by suction filtering with a 5C paper filter (retention particle diameter: 1 μm).

Amount of solution after the removal was adjusted to 1000 ml (0.74 mol/l as CD-3)

The pH at the finishing time was adjusted to 7.2.

Confirmation of sulfate ion concentration: It was confirmed by analyzing by ion chromatography that the sulfate ion concentration was 0.70 mol/l (the removal ratio of 20 percent), that is, a molar ratio with respect to the developing agent was 0.2.

Confirmation of the CD-3 concentration: It was confirmed by analyzing by liquid chromatography that the CD-3 was 0.74 mol/l.

Analysis Conditions

1) Ion chromatography

.HPLC

Manufactured by JASCO CORP

DG-980-50 Degasser

PU-980 Intelligent HPLC PUMP

LG-980-02 LOW PRESSURE GRADIENT UNIT

AS-950 Intelligent autosampler

CO-960 Column oven

LCSS-905 System station

Detector

Manufactured by SHOWA DENKO KK

Shodex CD-5 Electric conductivity detector for ion chromatography

.Column

Manufactured by SHOWA DENKO KK

Shodex ICI-524A

Eluent

Aqueous solution of 2.5 mM * o-phthalic acid (manufactured by Tokyo Kasei Kogyo Co., Ltd.) pH 4.0 (adjusted with an aqueous solution of 0.1 M * tris (hydroxymethyl) aminomethane (manufactured by Tokyo Kasei Kogyo Co., Ltd.))

| | |
|---|---|
| Flow rate | 1.2 ml/minute |
| Temperature | 40 degree centigrade |

2) Liquid chromatography

.HPLC

Manufactured by JASCO CORP

DG-980-50 Degasser

PU-980 Intelligent HPLC PUMP

LG-980-02 LOW PRESSURE GRADIENT UNIT

AS-950 Intelligent autosampler

CO-960 Column oven

LCSS-905 System station

.Detector

Manufactured by JASCO CORP

UV-970 intelligent UV/VIS detector

.Column

Manufactured by JASCO CORP

Finepack SIL C18S

.Eluent

3.75 mM phosphoric acid (manufactured by Kanto Chemical CO INC) pH: 4.0 (adjusted with potassium hydroxide (manufactured by Kanto Chemical CO INC): acetonitrile (manufactured by Kanto Chemical CO INC)=1:1

| | |
|---|---|
| Flow rate | 1.0 ml/minute |
| Temperature | 40 degree centigrade |

.Composition of coating solution

In compositions of the coating solutions used in the respective embodiments, the color developing agent part solution and the alkali part processing solution that were obtained according to the manufacturing examples were adjusted as shown in Tables 1 through 3 below.

Compositions of Color Developing Agent Part Solution

TABLE 1

| | A1 | A2 | A3 | A4 | A5 | A6 | A7 | A8 | A9 |
|---|---|---|---|---|---|---|---|---|---|
| Deionized water | + | + | + | + | + | + | + | + | + |
| CD-4.sulfate (g/L) | 58.5 | 292.3 | 146.2 | 58.5 | 146.2 | 146.2 | 292.3 | 365.4 | 365.4 |
| (mol/L) | 0.2 | 1.0 | 0.5 | 0.2 | 0.5 | 0.5 | 1.0 | 1.3 | 1.3 |
| Potassium bisulfite | 20.3 | 101.3 | 50.7 | 20.3 | 50.7 | 50.7 | 101.3 | 126.7 | 126.7 |
| (g/L) | | | | | | | | | |
| NMP (g/L)* | 17.5 | 87.7 | 43.9 | 17.5 | 43.9 | 43.9 | 87.7 | 109.7 | 109.7 |
| DEG (g/L)** | 17.5 | 87.7 | 43.9 | 17.5 | 43.9 | 43.9 | 87.7 | 109.7 | 109.7 |
| Sulfate removal | ◯ | — | — | ◯ | ◯ | ◯ | ◯ | ◯ | ◯ |
| process | | | | | | | | | |
| (1) | 0.5 | 1.0 | 1.0 | 0.5 | 0.2 | 0.2 | 0.0 | 0.0 | 0 |
| (2) (pH) | 6.8 | 2.0 | 4.0 | 8.0 | 7.2 | 7.2 | 7.2 | 7.2 | 7.2 |
| Total amount of | 1000 | 1000 | 1000 | 1000 | 1000 | 1000 | 1000 | 1000 | 1000 |
| solution (ml) | | | | | | | | | |
| Coating amount | 30 | 30 | 60 | 90 | 30 | 60 | 30 | 30 | 60 |
| (ml/m²) | | | | | | | | | |
| Number of times of | 1 | 1 | 1 | 3 | 1 | 1 | 1 | 1 | 2 |
| coating (times) | | | | | | | | | |
| Feed amount of | 0.006 | 0.03 | 0.03 | 0.054 | 0.015 | 0.03 | 0.03 | 0.0375 | 0.15 |
| developing agent | | | | | | | | | |
| (mol/m²) | | | | | | | | | |
| | (3) | (3) | (3) | (4) | (4) | (4) | (4) | (4) | (4) |

*N-methyl-2-pyrohlidone
**Diethylene glycol
(1) Molar ratio of sulfate/CD-4 when the sulfate of the CD-4 is removed according to the method described in the manufacturing method.
(2) Adding KOH according to the method described in the manufacturing method followed by adjusting the pH to the following values.
(3) Comparative embodiment.
(4) Present invention.

Alkali Part Solution Fundamental Composition

TABLE 2
Alkali part solution

| Alkali part solution | | |
|---|---|---|
| | Dissolution water | + |
| | NaBr | 0.024 g |
| | Additive | described in Table 3 |
| | | Adding water to 1 L |
| | | Adding NaOH, H2SO4 to adjust |
| | | the ph to that described in Table |
| | | 3 |

Alkali Part Solution Composition

TABLE 3

| | | Addition | | | Coating | Times of | |
|---|---|---|---|---|---|---|---|
| | | amount | | pH | amount | coating | |
| | PH buffering agent | (mol/l) | pka | (−) | (ml/m²) | Times | |
| B1 | None | — | — | 13 | 160 | 1 | (1) |
| B2 | None | — | — | 12 | 160 | 1 | (1) |
| B3 | K₂CO₃ (carbonic | 0.350 | 10.33 | 13.6 | 160 | 1 | (1) |
| | acid) | | | | | | |
| B4 | H₃PO₄ | 0.251 | 12.35 | 12.7 | 160 | 1 | (1) |
| B5 | H₃PO₄ | 0.251 | 12.35 | 12 | 160 | 1 | (1) |
| B6 | H₃PO₄ | 0.251 | 12.35 | 11.5 | 160 | 1 | (1) |
| B7 | H₂SiO₂(OH)₂ | 0.71 | 13.1 | 12 | 160 | 1 | (1) |
| B8 | (HOH₄C₂)₃-N | 0.71 | 7.9 | 12 | 160 | 1 | (1) |
| B9 | K₂CO₃ (carbonic | 0.71 | 10.33 | 12 | 160 | 1 | (2) |
| | acid) | | | | | | |
| B10 | I-1 | 0.71 | 9.78 | 12 | 160 | 1 | (2) |
| B11 | I-3 | 0.71 | 9.87 | 12 | 160 | 1 | (2) |
| B12 | I-3 | 0.355 × 2 | 9.87 | 12 | 80 | 2 | (2) |
| B13 | I-3 | 0.474 × 3 | 9.87 | 12 | 53 | 3 | (2) |
| B14 | I-3 | 0.355 × 4 | 9.87 | 12 | 40 | 4 | (2) |
| B15 | I-4 | 0.71 | 10.26 | 12 | 160 | 1 | (2) |
| B16 | I-4 | 0.355 × 2 | 10.26 | 12 | 80 | 2 | (2) |
| B17 | I-4 | 0.474 × 3 | 10.26 | 12 | 53 | 3 | (2) |
| B18 | I-4 | 0.355 × 4 | 10.26 | 12 | 40 | 4 | (2) |
| B19 | I-4 | 0.71 | 10.26 | 11.5 | 160 | 1 | (2) |
| B20 | I-4 | 0.71 | 10.26 | 11 | 160 | 1 | (2) |
| B21 | I-15 | 0.71 | 9.62 | 12 | 160 | 1 | (2) |
| B22 | I-20 | 0.71 | 9.08 | 12 | 160 | 1 | (2) |
| B23 | I-3/I-4 | 0.355/0.355 | 9.87/10.26 | 12 | 160 | 1 | (2) |
| B24 | I-4/II-1 | 0.50/0.21 | 10.26/10.23 | 12 | 160 | 1 | (2) |
| B25 | I-4/II-5 | 0.50/0.21 | 10.26/10.84 | 12 | 160 | 1 | (2) |
| B26 | I-4/II-6 | 0.50/0.21 | 10.26/10.27 | 12 | 160 | 1 | (2) |
| B27 | I-4/III-17 | 0.50/0.21 | 10.26/9.00 | 12 | 160 | 1 | (2) |
| B28 | I-4/III-1 | 0.50/0.21 | 10.26/9.12 | 12 | 160 | 1 | (2) |
| B29 | I-3 | 0.355 × 4 | 10.26 | 12 | 32 | 4 | (2) |
| B30 | I-3 | 0.355 × 4 | 10.26 | 12 | 64 | 4 | (2) |
| B31 | I-4 | 0.355 × 4 | 10.26 | 12 | 32 | 4 | (2) |
| B32 | I-4 | 0.355 × 4 | 10.26 | 12 | 64 | 4 | (2) |
| B33 | II-1 | 0.71 | 10.23 | 12 | 160 | 1 | (2) |
| B34 | II-1 | 0.178 | 10.23 | 12 | 160 | 1 | (2) |

(1) Comparative embodiment
(2) Present invention

Comparative Prescription

Furthermore, as a comparative prescription, a general processing solution in which the developing agent and the alkali part are mixed was taken as comparative embodiment 1.

| Comparative embodiment 1 | Single solution composition |
|---|---|
| Dissolution water | + |
| Sodium bromide | 0.013 mol |
| Hydroxylamine sulfate | 0.03 mol |
| Sodium bisulfite | 0.014 mol |
| Potassium carbonate | 0.28 mol |
| 4-amino-3-methyl-N-ethyl-N-(2- | 0.015 mol |
| hydroxyethylamine)monosulfate | |
| Adding water to 1 L | |

Adjusting pH to 10.15 with KOH and Sulfuric Acid

Furthermore, an acidic developing agent part solution that is usually supplied as a kit solution of the developing solution was used as a comparative embodiment.

<Embodiment 1>

Evaluation items: Evaluation of concentration rise and image reproducibility

Apparatus used: Coating machine Slit orifice coater When a photosensitive material is transferred, a slit having a width of 25 mm and a depth of 0.1 mm is used, and with the photosensitive material transferring at 5 mm/sec, the coating solution is fed on a photosensitive material surface.

A feed amount of chemicals is adjusted by controlling an amount of the solution exhausted from a nozzle.

Alternatively, by use of a fixed knife as a measuring jig, the feed amount of the chemical is adjusted by controlling a coating thickness of the chemical.

Photosensitive material: As a photosensitive material, AGFA Vista 800 was used.

Test piece Wedge exposed one: One that is wedge-exposed at 21 steps at a color temperature of 5500 degree Kelvin by use of a JIS III type photometer manufactured by MESS-TEK Corp.

Actual picture: Photographs of the same image that were taken by use of a camera at exposure levels of two step over, normal, and two step under were used.

Processing Process

(1) Coating of the color developing agent part solution:

10 seconds, 50 degree centigrade

(2) Coating of the alkali part solution:

60 seconds, 50 degree centigrade

(3) Coating of the development stop solution:

10 seconds, 50 degree centigrade

(4) Coating of the fixing solution:

70 seconds, 50 degree centigrade

(5) Coating of the bleaching solution:

30 seconds, 50 degree centigrade

(6) Coating of the stabilizing solution:

30 seconds, 50 degree centigrade

(7) Drying: 1 minute, 60 degree centigrade

(8) Image evaluation:

Prescriptions of processing solutions after the development stop solution were as follows.

<Preparation of processing solutions>

| | | |
|---|---|---|
| <Development stop solution> | | |
| Citric acid monohydrate | 100 | g |
| Adding water to 1 L | | |
| Adjusting pH to 1.62 | | |
| <Fixing solution> | | |
| Ammonium thiosulfate | 0.61 | mol |
| Ammonium bisulfite | 0.26 | mol |
| Triethylene tetramine | 0.175 | mol |
| Ethylenediamine tetraacetic acid | 0.02 | mol |
| Adding water to 1 L | | |
| Adjusting pH to 6.85 | | |
| <Bleaching solution> | | |
| Acetic acid | 0.84 | mol |
| 1,3-PDTA ferric salt | 0.315 | mol |
| Ammonium bromide | 70 | g |
| Ammonium nitrate | 70 | g |
| Adding water to 1 L | | |
| Adjusting pH to 4.5 | | |
| <Stabilizing solution> | | |
| Stearyl benzyldimethylmethyl ammonium chloride | 0.04 | g |
| Wettol (manufactured by Chugai Photo Chemical Co. | 0.50 | mol |
| Ltd.) | | |
| Dithio-2,2′-bisbenzmethylamide | 0.3 | g |
| Hydroxybenzoic acid propyl | 0.1 | g |
| Diethylene glycol | 0.5 | g |
| 37 percent by weight HCHO | 6.0 | g |
| Adding water to 1 L | | |

Evaluation Criteria

Evaluation Method (1)

By use of a densitometer X-Rite 310TR, a measurement is performed at Status M and a shape of the characteristic curve is evaluated, and thereby it is confirmed that gradations in high and low density portions are obtained.

Furthermore, whether the density differences ΔD (Dₘₐₓ−Dₘᵢₙ) of the respective colors were ≧0.8 or not was confirmed.

Evaluation Method (2)

A finished photosensitive material of an actual image is scanned by use of QSS3001 Digital Automatic Processor manufactured by Noritu Koki Co. Ltd. followed by image processing by use of Adobe Photoshop Ver.6.0 further followed by printing out processed image data by means of QSS3001 Digital Automatic Processor manufactured by Noritu Koki Co. Ltd., and whether the finishing level same as that according to the C41 process could be obtained or not was evaluated.

O: Image identical as that according to the C41 process

X: One that has an image but cannot be subjected to image processing because of poor color balance and inferior image reproducibility

X X: One having no gradation and no reproducibility

Overall Judgment

The evaluation was carried out according to the above evaluation method and the following overall judgments were carried out.

The test results are shown in the following Table 4.

TABLE 4

| CD-A | CD-B | | | | | | | | | |
|---|---|---|---|---|---|---|---|---|---|---|
| Sample | Developing | Alkali | ΔD | | | Actual image | | | Overall | |
| No. | agent solution | solution | Y | M | C | Under | Normal | Over | Judgment | |
| C1 | Single | — | 0.93 | 0.66 | 0.51 | x | x | Δ | x | (1) |
| | solution | | | | | | | | | |
| | coating agent | | | | | | | | | |
| C2 | A1 | B1 | 1.53 | 0.55 | 0.49 | x | x | Δ | x | (1) |
| C3 | A2 | B1 | 1.51 | 0.53 | 0.47 | x | x | Δ | x | (1) |
| C4 | A3 | B1 | 1.46 | 0.52 | 0.5 | x | x | Δ | x | (1) |
| C5 | A4 | B1 | 1.24 | 0.5 | 0.59 | x | x | Δ | x | (1) |
| C6 | A5 | B1 | 1.25 | 0.51 | 0.6 | x | x | Δ | x | (1) |
| C7 | A6 | B1 | 1.23 | 0.52 | 0.57 | x | x | Δ | x | (1) |
| C8 | A7 | B1 | 1.24 | 0.51 | 0.58 | x | x | Δ | x | (1) |
| C9 | A8 | B1 | 1.27 | 0.51 | 0.61 | x | x | Δ | x | (1) |
| C10 | A9 | B1 | 1.3 | 0.53 | 0.64 | x | x | Δ | x | (1) |
| C11 | A1 | B15 | 1.15 | 0.95 | 0.69 | Δ | Δ | Δ | Δ | (1) |
| C12 | A2 | B15 | 1.11 | 0.93 | 0.68 | Δ | Δ | Δ | Δ | (1) |
| C13 | A3 | B15 | 1.27 | 1.04 | 0.71 | Δ | Δ | Δ | Δ | (1) |
| C14 | A4 | B15 | 1.33 | 1.09 | 1.03 | ◯ | ◯ | ◯ | ◯ | (2) |
| C15 | A5 | B15 | 1.32 | 1.1 | 1.01 | ◯ | ◯ | ◯ | ◯ | (2) |
| C16 | A6 | B15 | 1.35 | 1.11 | 1.02 | ◯ | ◯ | ◯ | ◯ | (2) |
| C17 | A7 | B15 | 1.32 | 1.13 | 1.09 | ◯ | ◯ | ◯ | ◯ | (2) |
| C18 | A8 | B15 | 1.32 | 1.13 | 1.08 | ◯ | ◯ | ◯ | ◯ | (2) |
| C19 | A9 | B15 | 1.35 | 1.11 | 1.08 | ◯ | ◯ | ◯ | ◯ | (2) |
| C20 | A2 | B2 | 1 | 0.44 | 0.42 | x | x | x | x | (1) |
| C21 | A2 | B3 | 1.33 | 0.8 | 0.62 | x | Δ | Δ | Δ | (1) |
| C22 | A2 | B5 | 1.17 | 0.59 | 0.55 | x | x | Δ | x | (1) |
| C23 | A2 | B7 | 1.6 | 0.15 | 0.52 | x | x | x | x | (1) |
| C24 | A2 | B8 | 0.76 | 0.33 | 0.31 | x | x | x | x | (1) |
| C25 | A2 | B9 | 1.6 | 1.05 | 0.69 | Δ | Δ | ◯ | Δ | (1) |
| C26 | A2 | B10 | 1.14 | 0.96 | 0.63 | Δ | Δ | Δ | Δ | (1) |
| C27 | A2 | B11 | 1.12 | 0.9 | 0.7 | Δ | Δ | Δ | Δ | (1) |
| C28 | A2 | B21 | 1.1 | 0.99 | 0.6 | Δ | Δ | Δ | Δ | (1) |
| C29 | A2 | B22 | 1.3 | 1.13 | 0.59 | x | Δ | Δ | Δ | (1) |
| C30 | A7 | B2 | 1 | 0.44 | 0.42 | x | x | x | x | (1) |
| C31 | A7 | B3 | 1.53 | 0.54 | 0.92 | x | Δ | Δ | Δ | (1) |
| C32 | A7 | B4 | 1.37 | 0.2 | 0.77 | x | x | x | x | (1) |
| C33 | A7 | B5 | 1.17 | 0.59 | 0.55 | x | x | Δ | x | (1) |
| C34 | A7 | B6 | 1.01 | 0.51 | 0.35 | x | x | x | x | (1) |
| C35 | A7 | B7 | 1.57 | 0.42 | 0.43 | x | x | Δ | x | (1) |
| C36 | A7 | B8 | 0.76 | 0.33 | 0.31 | x | x | x | x | (1) |
| C37 | A7 | B9 | 1.55 | 1.14 | 0.94 | ◯ | ◯ | ◯ | ◯ | (2) |
| C38 | A7 | B10 | 1.05 | 0.97 | 0.89 | ◯ | ◯ | ◯ | ◯ | (2) |
| C39 | A7 | B11 | 0.99 | 0.85 | 0.9 | ◯ | ◯ | ◯ | ◯ | (2) |
| C40 | A7 | B12 | 1.05 | 0.8 | 0.85 | ◯ | ◯ | ◯ | ◯ | (2) |
| C41 | A7 | B13 | 1.01 | 0.87 | 0.92 | ◯ | ◯ | ◯ | ◯ | (2) |
| C42 | A7 | B14 | 0.92 | 0.83 | 0.81 | ◯ | ◯ | ◯ | ◯ | (2) |
| C43 | A7 | B16 | 1.07 | 0.8 | 0.82 | ◯ | ◯ | ◯ | ◯ | (2) |
| C44 | A7 | B17 | 1.02 | 0.91 | 0.93 | ◯ | ◯ | ◯ | ◯ | (2) |
| C45 | A7 | B18 | 0.94 | 0.86 | 0.8 | ◯ | ◯ | ◯ | ◯ | (2) |
| C46 | A7 | B19 | 0.92 | 1.19 | 0.92 | ◯ | ◯ | ◯ | ◯ | (2) |
| C47 | A7 | B20 | 0.96 | 1.27 | 0.89 | ◯ | ◯ | ◯ | ◯ | (2) |
| C48 | A7 | B21 | 1.02 | 0.94 | 0.87 | ◯ | ◯ | ◯ | ◯ | (2) |
| C49 | A7 | B22 | 1.19 | 1.22 | 0.87 | ◯ | ◯ | ◯ | ◯ | (2) |
| C50 | A7 | B23 | 0.95 | 0.91 | 0.85 | ◯ | ◯ | ◯ | ◯ | (2) |
| C51 | A7 | B24 | 1.02 | 0.87 | 0.93 | ◯ | ◯ | ◯ | ◯ | (2) |
| C52 | A7 | B25 | 0.98 | 0.92 | 0.97 | ◯ | ◯ | ◯ | ◯ | (2) |
| C53 | A7 | B26 | 1.04 | 0.95 | 0.9 | ◯ | ◯ | ◯ | ◯ | (2) |
| C54 | A7 | B27 | 0.9 | 0.85 | 0.81 | ◯ | ◯ | ◯ | ◯ | (2) |
| C55 | A7 | B28 | 0.92 | 0.86 | 0.83 | ◯ | ◯ | ◯ | ◯ | (2) |

(1): Comparative embodiment
(2): Present invention
◯: One that can be sufficiently used as a product
Δ: One that is partially problematic
x: One that cannot be used as a product.

As shown by the above results, it was confirmed that when the color developing solution according to the invention was used, irrespective of the under, normal or over exposure, excellent quality images could be obtained.

<Embodiment 2>

Evaluation items: Evaluation of the density rise and image reproducibility

Apparatus used

Coating of color developing agent part solution: Performing a coating test by use of a Canon BJ printer.

With a BJC-210J printer, the color developing agent part solution is charged in a BX-3 ink cartridge and coated.

Thereafter, with a coating medium set to a BJ cloth, printing quality to fine, and a mode to error diffusion mode, the solution was discharged. A coating amount was set at 37 ml/m².

Coating of alkali solution Coating machine: Slit orifice coater.

When the photosensitive material is transferred, by use of a slit having a nozzle width of 25 mm and a nozzle depth of 0.1 mm, with the photosensitive material transferring at 5 mm/sec, a coating solution was fed on a surface of the photosensitive material.

A feed amount of the chemical is controlled by an amount of solution exhausted from the nozzle. Alternatively, a feed amount of the chemical, by using a fixed knife as a measuring jig, is controlled by controlling a coating thickness of the chemical. Furthermore, a coating portion is left in an open state.

Photosensitive material: MAX Beauty 400 manufactured by Eastman Kodak Corp. was used as the photosensitive material.

Test piece: Wedge exposed one: One that is wedge-exposed under a color temperature of 5500 degree Kelvin by use of a JIS III type photometer manufactured by MESS-TEK Corp.

Actual picture: Photographs of the same image were taken by use of a camera at exposure levels of two step over, normal, and two step under.

Preparation of Coating Solution

The compositions of the solutions after the bleaching step were made identical as that of Embodiment 1.

When the compositions of the solutions after the bleaching step are deteriorated owing to the processing, the following solutions for replenishment can be used to complement.

<Bleaching solution for replenishment>

| | | |
|---|---|---|
| Acetic acid | 1.2 | mol |
| 1,3-PDTA ferric salt | 0.45 | mol |
| Ammonium bromide | 100 | g |
| Ammonium nitrate | 100 | g |
| Adding water to 1 L | | |
| Adjusting pH to 3.5 | | |
| <Fixing solution for replenishment> | | |
| Ammonium thiosulfate | 1.22 | mol |
| Ammonium bisulfite | 0.52 | mol |
| Triethylene tetramine | 0.35 | mol |
| Ethylenediamine tetraacetic acid | 0.04 | mol |
| Adding water to 1 L | | |
| Adjusting the pH to 6.85 | | |
| <Stabilizing solution for replenishment> | | |
| Stearyl benzyldimethyl ammonium chloride | 0.04 | g |
| Wettol (manufactured by Chugai Photo Chemical Co. | 0.50 | ml |
| Ltd.) | | |
| Dithio-2,2′-bisbenzmethylamide | 0.3 | g |
| Hydroxybenzoic acid propyl | 0.1 | g |
| Diethylene glycol | 0.5 | g |
| 37 percent by weight HCHO | 6.0 | g |
| Adding water to 1 L | | |

Processing method
(1) Coating of the color developing agent part 30 seconds, 50 degree centigrade solution
(2) Coating of the alkali part 45 seconds, 50 degree centigrade
(3) Impregnation of the bleaching solution 45 seconds, 38 degree centigrade
(4) Impregnation of the fixing solution 90 seconds, 38 degree centigrade
(5) Stabilizing solution process 90 seconds, 35 degree centigrade
(6) Drying
(7) Image evaluation

Evaluation Criteria

Evaluation method (1) By use of a densitometer X-Rite 310TR, a measurement is performed at Status M and a shape of the characteristic curve is evaluated, and thereby it is confirmed that gradations in high and low density portions are obtained.

Furthermore, whether the density difference ΔD (Dₘₐₓ−Dₘᵢₙ) of the respective colors were ≧0.8 or not was confirmed.

Evaluation method (2) A finished photosensitive material of an actual image was scanned by use of QSS3001 Digital Automatic Processor manufactured by Noritu Koki Co. Ltd. followed by image processing by use of Adobe Photoshop Ver.6.0 further followed by printing out processed image data by means of QSS3001 Digital Automatic Processor manufactured by Noritu Koki Co. Ltd., and thereby whether the finishing level same as that according to the C41 process could be obtained or not was evaluated according to the following criteria.

O: Image identical as that according to the C41 process

X: One that has an image but cannot be subjected to image processing because of poor color balance and poor image reproducibility.

X X: One having no gradation and no reproducibility

Overall Judgment

According to the above evaluation method, the following overall judgments were carried out.

O: One that can be sufficiently used as a product

Δ: One that is partially problematic

X: One that cannot be used as a product.

The test results (overall evaluation) are shown in the following Table 5.

TABLE 5

| | CD-A | CD-B | | | | | | | | |
|---|---|---|---|---|---|---|---|---|---|---|
| Sample | Developing | Alkali | ΔD | | | Actual image | | | Overall | |
| No. | agent | solution | Y | M | C | Under | Normal | Over | Judgment | |
| D1 | Single | — | 0.87 | 0.67 | 0.6 | x | Δ | Δ | Δ | (1) |
| | solution | | | | | | | | | |
| D2 | A2 | B1 | 1.37 | 0.65 | 0.69 | x | Δ | Δ | Δ | (1) |
| D3 | A2 | B2 | 0.97 | 0.54 | 0.62 | x | x | Δ | x | (1) |
| D4 | A2 | B5 | 1.07 | 0.55 | 0.65 | x | x | Δ | x | (1) |
| D5 | A2 | B7 | 1.39 | 0.65 | 0.59 | x | Δ | Δ | Δ | (1) |
| D6 | A2 | B8 | 0.86 | 0.43 | 0.51 | x | x | x | x | (1) |
| D7 | A2 | B10 | 1.05 | 0.94 | 0.72 | Δ | Δ | Δ | Δ | (1) |
| D8 | A2 | B11 | 1.07 | 0.92 | 0.78 | Δ | Δ | Δ | Δ | (1) |
| D9 | A2 | B21 | 1.05 | 0.95 | 0.69 | Δ | Δ | Δ | Δ | (1) |
| D10 | A2 | B22 | 1.19 | 1 | 0.72 | Δ | Δ | Δ | Δ | (1) |
| D11 | A7 | B1 | 1.42 | 0.58 | 0.59 | x | x | Δ | x | (1) |
| D12 | A7 | B4 | 1.26 | 0.62 | 0.87 | Δ | Δ | Δ | Δ | (1) |
| D13 | A7 | B8 | 0.71 | 0.63 | 0.51 | x | x | Δ | x | (1) |
| D14 | A7 | B9 | 1.34 | 1.04 | 0.97 | ◯ | ◯ | ◯ | ◯ | (2) |
| D15 | A7 | B10 | 1.11 | 1.06 | 0.99 | ◯ | ◯ | ◯ | ◯ | (2) |
| D16 | A7 | B11 | 1.25 | 0.95 | 0.91 | ◯ | ◯ | ◯ | ◯ | (2) |
| D17 | A7 | B15 | 1.11 | 0.99 | 0.92 | ◯ | ◯ | ◯ | ◯ | (2) |
| D18 | A7 | B19 | 1.54 | 1.34 | 1.12 | ◯ | ◯ | ◯ | ◯ | (2) |
| D19 | A7 | B20 | 1.6 | 1.4 | 1.26 | ◯ | ◯ | ◯ | ◯ | (2) |
| D20 | A7 | B21 | 1.22 | 0.96 | 0.9 | ◯ | ◯ | ◯ | ◯ | (2) |
| D21 | A7 | B22 | 1.17 | 1.24 | 0.96 | ◯ | ◯ | ◯ | ◯ | (2) |
| D22 | A7 | B23 | 1.05 | 0.93 | 0.95 | ◯ | ◯ | ◯ | ◯ | (2) |
| D23 | A7 | B24 | 1.07 | 0.97 | 0.94 | ◯ | ◯ | ◯ | ◯ | (2) |
| D24 | A7 | B29 | 0.9 | 0.84 | 0.84 | ◯ | ◯ | ◯ | ◯ | (2) |
| D25 | A7 | B30 | 1.01 | 0.9 | 0.9 | ◯ | ◯ | ◯ | ◯ | (2) |
| D26 | A7 | B31 | 0.95 | 0.86 | 0.85 | ◯ | ◯ | ◯ | ◯ | (2) |
| D27 | A7 | B32 | 1.06 | 0.92 | 0.94 | ◯ | ◯ | ◯ | ◯ | (2) |

(1): Comparative embodiment
(2): Present invention

As shown in the Table, it was confirmed that even when the kinds of the photosensitive material were varied and various exposure conditions were adopted, when the color developing solution according to the present invention was used, high quality images could always be obtained.

Embodiments according to the invention are not restricted to the coating, but also can be applied to the impregnation method.

As mentioned above, according to the color developing solution of the silver halide color photographic photosensitive material of the present invention, various photosensitive materials are made acceptable, the workability can be improved.

What is claimed is:

1. A color developing solution of a silver halide color photographic photosensitive material, comprising:
a first processing solution containing a color developing agent having pH larger than 7; and
a second processing solution containing an alkali agent and at least one kind of compounds having pKa in a range of equal to or greater than 9 and equal to or less than 12, the second processing solution having pH smaller than 13.5.

2. The color developing solution, as set forth in claim 1,
wherein the first processing solution has a p-phenylenediamine type color developing agent in the range of 0.1 mol/l to 2 mol/l.

3. The color developing solution, as set forth in claim 1,
wherein the first processing solution has at least one kind of strong acid ions selected from the following compound group (A) by molar ratio of less than 1 with respect to p-phenylenediamine type color developing agent:
Compound group (A) Sulfate ion, chloride ion, nitrate ion, p-toluenesulfonate ion, and sulfonate ion.

4. The color developing solution as set forth in claim 1,
wherein the second processing solution containing the compound having the pKa in a range of equal to or greater than 9 and equal to or less than 12 is a compound shown in any one of the following general formulae (I), (II) and (III). 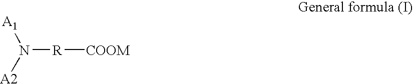
In the formula, A1, A2 each denote a hydrogen atom, a branched alkyl group having 1 to 6 carbon atoms, a straight chain alkyl group having 1 to 6 carbon atoms, A1 or A2 is connected with an R and form a heterocycle, R denotes a branched alkylene group having 1 to 10 carbon atoms, straight chain alkylene group having 1 to 10 carbon atoms or cyclic alkylene group having 1 to 10 carbon atoms, the alkylene group is substituted with one of an alkyl group having 1 to 3 carbon atoms, —OH, —NH₂, —SH, —PO₃M₂, —COOM, aryl group, indole group or guanidino group, the aryl group is partially substituted with an OH, the alkylene group and the substituent group are connected through —O—, —S—, and M denotes hydrogen atom or an alkali metal. 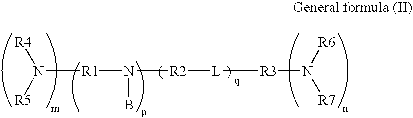
In the formula, R1, R2 each denote a branched alkylene group having 1 to 8 carbon atoms, a straight chain alkylene group having 1 to 8 carbon atoms or the alkylene group is substituted with —OH or —NH₂, R3 denotes a branched alkylene group having 1 to 8 carbon atoms, a straight chain alkylene group having 1 to 8 carbon atoms, a cyclic alkylene group having 1 to 8 carbon atoms or an alkan-tri-yl group, and the alkylene group or the alkan-tri-yl group is substituted with —OH or —NH₂, R4, R5, R6, R7 each denote a hydrogen atom, a branched alkyl group having 1 to 8 carbon atoms, a straight chain alkyl group having 1 to 8 carbon atoms, and a cyclic alkyl group having 1 to 8 carbon atoms or an aryl group, and the alkyl group and the aryl group is substituted with —COOM, —OH, or —PO₃M₂, B denotes a hydrogen atom, a branched alkyl group having 1 to 4 carbon atoms or a straight chain alkyl group having 1 to 4 carbon atoms and the alkyl group is substituted with —OH, —COOM, aryl group or —PO₃M₂. L denotes S or O, p and q each denote a number from 0 to 4, m+n denotes a number from 1 to 3, and M denotes a hydrogen atom or an alkali metal. 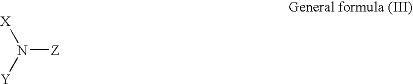
In the formula, X, Y, Z each denotes a hydrogen atom, a branched alkyl group having 1 to 8 carbon atoms or straight chain alkyl group having 1 to 8 carbon atoms, the alkyl group is substituted with —COOM, —OH, —NH₂, —SH, —PO₃M₂ or aryl group, the aryl group is substituted with —OH, X, Y and Z combine with each other and form a ring, and M denotes a hydrogen atom or an alkali metal.

5. The color developing solution, as set forth in claim 1
wherein the second processing solution includes at least one of the compound (I), the compound (II) and the compound (III) in a range of 0.07 mol/l to 2 mol/l.

6. The color developing solution, as set forth in claim 1
wherein the first processing solution supplies the color developing agent to the silver halide color photographic photosensitive material at a rate ranging from 0.01 mol/m² to 0.5 mol/m².

7. The color developing solution, as set forth in claim 1
wherein the first processing solution supplies the p-phenylenediamine type color developing agent to the photosensitive material at a rate ranging from 0.01 mol/m² to 0.5 mol/m².

8. A method of manufacturing a color developing solution of a silver halide color photographic photosensitive material having a first processing solution containing a color developing agent having pH larger than 7, and a second processing solution containing an alkali agent, comprising the steps of:
adding a neutralizing agent to an aqueous solution of an acid adduct of the p-phenylenediamine type color developing agent to have the neutralizing agent react with the strong acid ion; and
precipitating and removing a reaction product obtained according to the reaction.

9. The method of manufacturing the color developing solution, as set forth in claim 8
wherein an amount of the neutralizing agent to be added is in a range of 0.5 to 2.5 times by mole of an acid adducted to the color developing agent.

10. The method of manufacturing the color developing solution, as set forth in claim 8
wherein an ion concentration of the strong acid ion is less than 1 time by mole that of the color developing agent.

11. A color development processing agent producted by a process comprising the steps of:
adding a neutralizing agent from 0.5 to 2.5 times by mole of an acid adducted to the color developing agent to an aqueous solution of an acid adduct of the p-phenylenediamine type color developing agent, and
precipitating and removing a reaction product obtained according to the reaction.
